(19) United States
(12) Patent Application Publication
(10) Pub. No.: US 2024/0228752 A1
(43) Pub. Date: Jul. 11, 2024

(54) METHOD FOR PREPARING STRUCTURALLY COLOURED FILMS AND PIGMENTS

(71) Applicant: SPARXELL UK LIMITED, London (GB)

(72) Inventors: Silvia VIGNOLINI, London (GB); Benjamin E. DROGUET, London (GB); Hsin-Ling LIANG, London (GB); Bruno FRKA-PETESIC, London (GB); Michael DE VOLDER, London (GB); Jeremy J. BAUMBERG, London (GB); Richard PARKER, London (GB)

(21) Appl. No.: 18/691,648

(22) PCT Filed: Aug. 24, 2022
(86) PCT No.: PCT/EP2022/073629

§ 371 Date: Mar. 13, 2024

(30) Foreign Application Priority Data
Aug. 24, 2021 (GB) 2112102.5

(51) Int. Cl. C08L 1/04; C08J 7/04; C09D 7/65; C09K 19/02; C09K 19/38

(52) U.S. Cl. CPC C08L 1/04; C09K 19/02; C08J 7/0427; C09D 7/65; C09K 19/3819

(57) ABSTRACT

The invention relates to a method for producing structurally coloured films, particles and interference pigments comprising cellulose nanocrystals, such as neutralised cellulose nanocrystals. The films and particles can be used as interference pigments or coloured particles such as glitters for various applications. The method comprises steps of depositing a nanocrystal suspension comprising cellulose nanocrystals onto a substrate: spreading the nanocrystal suspension across the substrate using a spreader: ageing the nanocrystal suspension to partially or completely recover the cholesteric structures lost during deposition and spreading: drying the deposited nanocrystal suspension so that the nanocrystals self-assemble to form a structurally coloured film: and annealing the structurally coloured film to increase the water resistance of the film. The structurally coloured film comprises nanocrystals which are organized into chiral nematic structures to provide the structural colour.

### RELATED APPLICATION

The present case claims priority to, and benefit of, GB 2112102.5 filed on 24 Aug. 2021 (24.08.2021), the contents of which are hereby incorporated by reference in their entirety.

### FIELD OF THE INVENTION

The present invention provides methods for preparing coloured films from colloidal nanoparticles, such as cellulose nanocrystals. In particular, the invention provides industrially scalable methods for producing such films. The films can be used to form particles that can be used as interference pigments or coloured particles such as glitters.

### BACKGROUND

Cellulose nanocrystals are rod-shaped colloidal particles that can be extracted from a variety of natural sources, such as cotton, wood or woodpulp, producing stable aqueous suspensions that may exhibit cholesteric (also refer to as chiral nematic) liquid crystalline behaviour above a specific concentration which can be reached for instance upon solvent evaporation.

The evaporation of a cellulose nanocrystal suspension on a flat substrate results in the formation of a solid film with a periodic chiral structure that can reflect visible light. For example, Revol et al. (J. Pulp Paper Science 1998, 24, 146) described the preparation of reflective films prepared from a suspension of cellulose nanocrystals that was deposited on a Teflon surface. The films were shown to have structural colour in the infra-red (IR), ultraviolet (UV) and visible ranges.

Park et al. (Chem. Phys. Chem. 2014, 15, 1477) have studied the formation of films prepared from suspensions of cellulose nanocrystals deposited onto large (25 mm wide) glass slides. The authors also looked at the effects of shear flow on the formation of helical structures within the film, and the film formation is studied whilst the suspension is dried under orbital shaking. Here, it is said that the shear flow in this configuration ensures a uniformly aligned vertical cholesteric structures restricted to the central part of the sample. However, the shear flow does not prevent variations in the pitch of the helix.

As more sustainable approaches to produce functional materials are desperately needed, structurally coloured materials obtained from the self-assembly of plant-derived cellulose nanocrystals (CNCs) have attracted significant interest among the scientific community and beyond. As noted above, colloidal cellulose nanocrystals can self-assemble in suspension upon solvent evaporation into periodic chiral nematic structures that can reflect vivid and durable photonic colour. The interference colour follows Bragg's law when the characteristic size of the periodic arrangement of cellulose nanocrystal known as the pitch is of the same size range as the wavelengths of the interfering light, which can be for instance visible, near IR or near UV light (see Parker et al., Adv. Mater. 2018, 30, 1704477).

The processes regulating the self-assembly of cellulose nanocrystals are now understood sufficiently to envision a wide range of applications, from sensors to anti-counterfeiting and decorative purposes. However, there is still a lack of scalable methodologies to produce large scale coloured cellulose nanocrystals films.

Continuous deposition of cellulose nanocrystal suspensions to produce transparent films have been reported using a roll-to-roll (R2R) printing or coating approach. For those transparent films, the cellulose nanocrystals are typically aligned parallel to the substrate along the coating direction as a result of the high shear applied during the R2R deposition process, and this anisotropy along the coating direction is retained in the final cellulose film resulting in a lack of colour. Structurally coloured cellulose nanocrystal films with chiral nematic order have only been demonstrated over comparatively small areas. Most existing methods for producing such structurally coloured films employ drop-casting within shallow Petri-dishes¹⁰⁻¹². Drop-casting, as a batch method, is not industrially scalable as it does not permit continuous manufacturing.

Continuous manufacturing processes such as roll-to-roll or other similar printing or coating techniques impose restrictions on the rheological properties of the deposited materials. The deposited materials need to be sufficiently viscous and cohesive for good coverage and to avoid cracking and shrinkage upon drying, but also able to meet the limited time window available for solvent evaporation during continuous processing.

In order to provide cellulose nanocrystal photonic materials of good optical quality (e.g. vivid coloured films), long evaporation times and initially-low cellulose nanocrystal content (giving low viscosity) are known to be required to enable optimum self-assembly to occur.

However, producing structurally coloured particles of good optical quality from the self-assembly of cellulose nanocrystal remains challenging, and has yet to be demonstrated using a scalable method.

WO 2018/033584 describes a method to produce particles having self-assembled nanocrystals of cellulose through microfluidics. The radial alignment of the chiral nematic inside spherical particles leads to less angular dependant reflection compared to previously reported flat dish cast films, and the reflection of incident light from the structure of the particle is weak as a result of the buckling of the particles' spherical interface upon solvent drying, preventing their use as pigments. The microfluidic process described in WO 2018/033584 forms individual particles and a process of preparing films is not described.

WO 2014/118466 concerns a method to mark cigarette paper and describes a batch method to produce particles from iridescent cellulose nanocrystal film. However, the particles in this document are not visible to the naked eye, and the iridescence and optical response of the particles and films is not disclosed. Additionally, the particles are said to collapse within few hours after immersion in water, resulting in significant particles mass loss and preventing their use as pigments. The use of two post-treatments (one aiming at removing sulphur groups and one aiming at screening charges with salt) did not provide any significant improvement in retaining the structure of the particles. The films produced by this methods are said to have a thickness of at least 20 μm.

Zhao et al. (Adv. Funct. Mater. 2019, 29, 1804531) prepared structurally coloured microfilms comprising cellulose particles having diameters larger than 600 μm using an offset printing technique to produce sub-millimeter scale microfilms on glass and other silanizable substrates such as PDMS. Highly ordered chiral nematic structures are obtained by keeping the printed films under oil and drying for up to 2 days in order to limit the “coffee stain” effect that occurs at the microdroplet boundary. However, this drying method greatly limits the scalability of the process. Additionally, the microdroplets of cellulose ink were deposited on a sacrificial layer such that the microdroplets were tightly bound to the substrate. As a result, the microfilms are not retrieved as individual particles, and their use as a pigment is not demonstrated. Importantly, the films are highly sensitive to ambient moisture, which suggests that their structure can collapse upon immersion in water.

WO 2017/091893 describes a method for preparing cellulose-based pigments that relies on a core of cellulose aggregates which are dyed with chemicals to produce colour through a light absorption mechanism.

Nan et al. (ACS Sustain. Chem. Eng. 2017, 5, 8951-8958) showed that treating cellulose nanocrystals films with strong sodium hydroxide from 3 h to up to 12 h slightly increases the water permeation of the films in alkaline water. However, even with the longest treatment times, the films can collapse and the constitutive nanocrystals redisperse when immersed in water, preventing any use in such liquid.

The present invention provides alternatives to the known processes for producing cellulose nanocrystal-based films and particles having structural colour. Preferably, the present invention solves one or more of the problems associated with the prior art methods.

### SUMMARY OF THE INVENTION

The present invention relates to a method for producing structurally coloured films, particles and interference pigments comprising cellulose nanocrystals, such as neutralised cellulose nanocrystals.

The films have structural colour, of which the colour may be visible colour, infrared colour or ultraviolet colour. The structural colour derives from the presence of the chiral nematic structures, which gives rise to strong reflections at specific wavelengths.

Generally, the invention provides a process for producing structurally coloured films, the process comprising the steps of:
a) depositing a nanocrystal suspension comprising cellulose nanocrystals onto a substrate using a coating applicator;
b) spreading the nanocrystal suspension across the substrate using a spreader; and
c) drying the deposited nanocrystal suspension so the nanocrystals self-assemble to form a structurally coloured film.

Preferably, the method comprises an ageing step between the spreading and drying steps. The ageing step allows the nanocrystal suspension to partially or completely recover any cholesteric structures lost during deposition and spreading.

In this way, structurally coloured films having high reflectivity and saturation may be reliably and reproducibly prepared on large scale using industrially viable methods.

In a first aspect of the invention, there is provided a process for producing structurally coloured films, the process comprising the steps of:
a) depositing a nanocrystal suspension comprising cellulose nanocrystals onto a substrate;
b) spreading the nanocrystal suspension across the substrate using a spreader;
c) ageing the nanocrystal suspension to partially or completely recover the cholesteric structures lost during deposition and spreading;
d) drying the deposited nanocrystal suspension so the nanocrystals self-assemble to form a structurally coloured film;
e) annealing the structurally coloured film to increase the water resistance of the film.

The method provides structurally coloured films having high reflectivity and saturation and with increased solvent resistance, and in particular increased water resistance.

In a second aspect of the invention there is provided a structurally coloured film obtainable by the method of the first aspect.

In a third aspect of the invention there is provided a structurally coloured film comprising cellulose nanocrystals, preferably neutralised cellulose nanocrystals, wherein the nanocrystals are organised into chiral nematic structures, preferably wherein the film has a thickness such that the director of a chiral nematic structure performs at least one revolution within the film, wherein the film as a thickness of 20 μm or less.

The highly ordered chiral nematic structures in the structurally coloured films of the second and third aspects are highly reflective and reflect highly saturated colors with high intensity.

In a fourth aspect of the invention there is provided a structurally coloured particle obtained or obtainable by dividing the structurally coloured film obtained or obtainable by the method of the first aspect.

In a fifth aspect of the invention there is provided a structurally coloured particle comprising cellulose nanocrystals, preferably neutralised cellulose nanocrystals, wherein the nanocrystals are organised into chiral nematic structures, preferably wherein the particles have a facetted geometry corresponding to at least one chiral nematic domain.

The highly ordered chiral nematic structures in the structurally coloured particles of the fourth and fifth result in high reflectivity, the structurally coloured particles maintain colouration when suspended in a solution such as water over long time periods.

In a sixth aspect of the invention there is provided the use of the structurally coloured particle of the fourth or fifth aspects in a cosmetic product, in packaging or in paints.

These and other aspects and embodiments of the invention are described in further detail below.

### SUMMARY OF THE FIGURES

The present invention is described with reference to the figures listed below.

FIG. 1 shows an overview of the R2R processing of CNC coatings into photonic microparticles. A) Schematic of the process of the invention using roll-to-roll coating and showing the potential reuse process of the web and pigment production. B) Red, green and blue R2R-coated CNC films deposited onto a black PET web (tip sonication for 6.44 s/mL (21.5 KJ/g), 4.36 s/mL (14.5 KJ/g) and 2.24 s/mL (7.5 KJ/g), respectively). C) Unrolled metre-long roll-to-roll coating of cellulose nanocrystals produced by a method of the invention (tip sonication for 4.36 s/mL (14.5 kJ/g). D) Pristine (left) and heat-treated (right) photonic CNC particles produced by a method of the invention including the fracturing step embedded in transparent varnish (prior to size-sorting). E) Heat-treated photonic CNC particles after size-sorting and immersed, from left to right, in ethanol, in 50% aqueous ethanol, and in water.

FIG. 2 shows the coating thickness and optical properties versus coating parameters. A) Macroscopic pictures (top row) and left-circularly polarised optical microscopy images (middle row) of CNC coatings and scanning electron microscopy (SEM) cross-section (bottom row) of the self-standing CNC films prepared through different coating gaps and speeds with a constant shear rate of 2.2 s⁻¹ (concentration equals to 6 wt. %, sonication for 56 s (2.24 s/mL or 7.5 KJ/g). B) Corresponding left-circularly polarised (LCP) reflectance spectra of the CNC coatings, averaged over 15+positions. C) The relationship between the wet coating gap and dry film thickness of samples in A. Dashed pink line highlights the theoretical minimum thickness required for a CNC film to reach maximal reflectance calculated with the Berreman 4×4 matrix method and taking refractive indexes as nₒ and nₑ of 1.514 and 1.590, as in previous work (for example see Zhao et al., Adv. Funct. Mater. 2019, 29, 1804531)

FIG. 3 shows the effect of sonication and drying conditions on the visual appearance of CNC coatings. A) Macroscopic photographs (first and third rows) and left-circularly polarised (LCP) optical microscopy images (second and bottom rows) of CNC coatings prepared using a method of the invention from CNC suspensions sonicated respectively at 56 s (2.24 s/mL or 7.5 KJ/g) at left, 109 s (4.36 s/mL or 14.5 KJ/g) at middle and 161 s (6.44 s/mL or 21.5 KJ/g) at right, at 6 wt. %, and dried either at 18° ° C. or 60° C. using a coating gap equals to 700 μm at a speed of 1.5 mm·s⁻¹. B) Corresponding LCP reflectance spectra of samples cast at room temperature (top) and on hot plate (bottom), averaged over 15+ locations.

FIG. 4 shows CNC photonic microparticles. A) Micrograph of size-sorted and heat-treated CNC photonic microparticles prepared from the R2R coating of a 6 wt. % CNC suspension sonicated for 196 s (4.36 s/mL or 14.5 KJ/g), coated according to a method of the invention, as observed in air, in ethanol, in a 1:1 (mass ratio) mixture of ethanol and water and in water. Microscopic views for the largest size depict the same particle. B) Corresponding total reflectance spectra of the size-sorted particles in the same four media, averaged over 10+ locations. C) SEM top views exemplifying CNC photonic particle morphology after fracturing for each size group. D) SEM cross-section of a CNC particle showing the typical Bouligand arches, characteristic of the CNC chiral nematic order, as typically obtained after fracturing of the roll-to-roll printed film in (A).

FIG. 5 shows the effect of tip sonication on the visual appearance of CNC films prepared from a 6 wt. % biphasic suspension. A) Macroscopic photographs. B) Corresponding micrographs through left-circularly polarised (LCP) filter. C) Corresponding reflection spectra through LCP (left) and RCP (right) filters averaged over 10+ locations. D) Corresponding CIE 1931 colour space chromaticity diagram calculated from Python's Colour package. The CIE coordinates are from blue to red: [0.20; 0.13], [0.32; 0.30], [0.40; 0.31], [0.50; 0.34], [0.42; 0.47] and [0.23; 0.44].

FIG. 6 shows the phase diagram of the CNC suspension used. A) Picture of glass capillaries filled with the starting CNC suspension of increasing concentration and viewed between cross polarisers. B) Volumetric ratio of anisotropic phase versus CNC concentration extracted from A).

FIG. 7 shows the effect of the annealing process. A) Effect of the temperature of heat-treatment (applied for 30 min) on the macroscopic and microscopic visual appearance of free-standing CNC samples cut from a CNC film produced by a method of the invention using roll-to-roll coating. B) Corresponding spectra in reflection and transmission (smoothed and averaged up to 3 locations). Measurements were taken using a 20× objective (Nikon T plan SLWD, NA=0.3) with a 200 μm-cored optical fibre (Thorlabs FC-UV200-2-SR).

FIG. 8 shows the effect of the occurrence of flow during film drying on the uniformity of the film produced using a method of the invention. A-C) Three different parts of the same R2R film produced on a misaligned web showing the accumulation of material on one side of the web (C, tail) and showing the effect of thickness variation on the uniformity of the film.

FIG. 9 shows a CNC film dried over a perforated hot plate. A-E) Photographs of a wet CNC film taken before complete drying and maintained over a perforated aluminium board placed over a hot plate set at 60° C. The film was preparing using a method of the invention through a coating gap of 700 μm at a coating speed of 1.5 mm/s. The temperature gradient between the aluminium board and the circular holes created a spatial drying rate difference across the suspension. B) A close-up view of A) where iridescent, self-organised domains are clearly visible in the still wet CNC film. F) The resulting dry and patterned CNC coating. G) LCP micrograph of the two areas dried at different rates. H) Corresponding LCP reflectance spectra of the two areas, with each spectrum averaged over 3+ locations.

FIG. 10 shows a flow chart describing the process disclosed in the present invention.

FIG. 11 shows the reversible colour change of a cellulose nanocrystal photonic particle. Microscope snapshots of a single cellulose nanocrystal photonic particles placed in a mixture of water and ethanol (from left to right): particle in air, particle in an evaporating mixture of ethanol and water, particle in water (ethanol evaporated and water condensation taking place) and particle back in air (water evaporated).

FIG. 12 shows the Iridescence of dispersed photonic CNC microparticles. A) Snapshots, taken at increasing illumination angles of green photonic CNC particles (size: 150>X>75 μm) dispersed in glycerol (particles prepared from a CNC suspension tip-sonicated for 196 s (4.36 s/mL or 14.5 KJ/g), loading of particles in the vial is approximately 5.5 mg/mL. From left to right, the angle of illumination increases and results in a strong apparent blue-shift, from green to blue and eventually beyond the visible spectrum. B) Schematic of the resulting reflection from samples displayed in (a). The orientation of the contributing particles is depicted in black. C) Photonic CNC particles (size: 75>X>25 μm,) embedded in transparent epoxy resin covering a glass slide and under direct illumination. From left to right, the angle of illumination increases and results in a reduced apparent blue-shift, from green to deep blue. D) Schematic of the resulting reflection from samples displayed in (c), highlighting the key role of air/coating interface to reduce the blue-shift, as per Snell's law. E) Same sample as in (c), but under diffuse illumination. F) Schematic of the resulting reflection from samples displayed in (e). The combination of diffuse illumination and the refractive index contrast of the air/coating interface results in suppression of most of the blue-shift, leading to an almost non-iridescent coating.

FIG. 13 shows the macroscopic visual appearance of CNC photonic particles embedded in a transparent epoxy resin. Photographs (top row) under diffuse illumination show that the larger particles give a pixelated appearance to the coating while the smaller particles appear much more uniform. Observed under the microscope mounted with a 5× objective (Zeiss, EC Epiplan Neofluar, NA=0.13) in bright and dark fields (BF and DF, second and third rows respectively), it appears that the larger particles tend to remain aligned to the glass substrate while the smaller particles are more randomly oriented. The loading of CNC photonic particles was approx. 15 mg for 150 mg of resin (Norland Optical Adhesive 81) and approx. 3.1 mg/cm². The mixture was applied on a glass slide and covered with a cover slip.

FIG. 14 shows the scattering measurement of photonic CNC microparticles embedded in a transparent epoxy resin (for the same samples as in FIG. 13). Samples are illuminated at θᵢₙ=0° (normal incidence, top row) or at θᵢₙ=30° (bottom row). As the size of the particles decrease, the scattered signal becomes smoother and more continuous to the point where it fits the signal of a randomized distribution of diffracting domains of identical pitch (white curves). This scattering signal is less iridescent that the equivalent scattering signal of a typical CNC film.

FIG. 15 shows computed reflectance versus film thickness, assuming refractive indices nₒ=1.514 and nₑ=1.590. A) Computed spectra of a cholesteric structure of incremented number of pitches (taking pitch p=318 nm) using a numerical model (Berreman 4×4 matrix method). The plot on the right is an expansion of the reflected peak, showing saturation after a number of helix N=24, corresponding to a film thickness of 7.6 μm. B) Computed maximal reflectance peak from three cholesteric structure made of a pitch p=318, 370 and 429 nm (corresponding to the peak wavelength of the blue, green, and red films displayed in FIG. 3.) versus film thickness, using an analytical model (De Vries equations). Reflectance>99.5% is reached for film thickness>6.9 μm, 8.1 μm and 9.3 μm for p=318, 370 and 429 nm respectively.

FIG. 16 shows more details about the processing of R2R-cast CNC films to CNC photonic microparticles (steps conducted after drying on the R2R machine indicated at the top of the figure). A) Detachment of the head of the dried CNC film from the PET web using a plastic blade (125 μm-thick). The CNC film was carried by its moving web (as it was still attached on one side) while detaching without breaking and gliding over another motionless web for collection. B) CNC photonic microparticles as obtained after drying, heat treatment and fracturing a R2R-cast film. C) CNC particles immersed in water:ethanol mixtures of various mass ratios (from left to right: 1:0, 95:5, 85:15, 70:30, 1:1, 0:1). D) Same samples as in (C) photographed 10 months later. E) Example of one possible application of CNC photonic microparticles in sparkling beverage. F) CNC photonic microparticles in a wider range of solvent of various polarity and ionic strength (from left to right: acetone, ethyl acetate, hexane, water with one droplet of industrial surfactant (Premiere Products, Savona D2), water containing 1 mM NaCl.

FIG. 17 shows the benchmarking of photonic CNC microparticles (ii, iv and vi) against commercial effect pigments (i), glitters (iii, v and vii) and photonic CNC buckled microspheres (viii). A) Photograph taken under directed illumination at ca 45° from the light source. B) Photograph taken under directed illumination at ca. 110° from the light source highlighting the peculiar angle-dependant visual response of the photonic CNC microparticles. Sample list: i. Merck Xirona® (Moonlight Sparks, size: 20-150 μm) ii. Photonic CNC microparticles (size: 150>X>75 μm). iii. Bio-Glitter® Pure (Sea green, size: 40 mil≈1 mm and Light gold, size: 15 mil˜ 380 μm). iv. Photonic CNC microparticles (size: X<25 μm). v. Bio-Glitter® Sparkle (Spring green, size: 8 mil˜ 200 μm). vi. Photonic CNC microparticles (size: X>150 μm). vii. Bio-Glitter® Pure (Sea green, size: 94 mil≈2.4 mm). viii. Photonic CNC microspheres. The loading of effect particles was approximately 10 wt. % except for sample (i) where the loading was reduced to 1 wt. %.

FIG. 18 shows the effect of heat-treatment temperature and duration on the hydrophilicity of the CNC films. A) Photographs (top row) of R2R-cast CNC film pieces heat-treated at 150° C. for increasing duration and placed in water. Photographs (second row) of R2R-cast CNC film pieces as retrieved after immersion in water and complete drying. B) Photographs (top row) of R2R-cast CNC film pieces heat-treated at 190° C. for increasing duration before being placed in water. All films display structural colour. Photographs (second row) of R2R-cast CNC film pieces during immersion in water. Scale bar: dish diameter equals 3.5 cm.

FIG. 19 shows the optical properties of CNC films cast by R2R and dried either statically or with stepwise continuous translation through an in-line hot air dryer. A) Images of a 4.2 m long blue R2R-cast film (dried by coarse stepwise method, T=60° C.) with insets showing the optical appearance at different positions along the length (P_{c} indicates position from coating head). Here the position is defined relative to the beginning of the deposition. B) Photographs (rows 1, 2 and 4) and optical micrographs (rows 3 and 5) of R2R-cast CNC films sonicated for 2.24 s/mL (7.5 KJ/g) recorded through LCP and RCP filters. C) Corresponding LCP and RCP reflectance spectra of the free-standing films reported in (b). The LCP reflectance spectra are averaged over 80+positions along the film. D) Drying time and thickness of the films for the different deposition methods and drying conditions. E) LCP optical micrographs of films prepared from CNC suspensions sonicated for 290 s (6.44 s/mL or 21.5 KJ/g) and dried either at 20° C.(left) or 60° C.(right). The top row shows blade-cast films (g_{c}=700 μm, v_{c}=1.5 mm·s⁻¹) while the bottom row shows R2R-cast films (static at T=20° C., coarse steps at T=60° C.). F) Corresponding LCP reflectance spectra, averaged over 15+ locations. G) Thickness measurements of the different films presented in (a).

FIG. 20 shows applications of the structurally coloured films and structurally colour films of the present invention. A) Particles divided to a square shape and presented over paper. B) Particles glued over a piece of fabric. C) Particles embedded in an edible host matrix and applied over a piece of chocolate. D) Particles used in a coating painted on a finger nail. E) Host polymer matrix containing the particles painted on a piece of wood.

### DETAILED DESCRIPTION OF THE INVENTION

The present invention relates to coloured films prepared from colloidal nanoparticles, such as cellulose nanocrystals.

Colloidal cellulose nanoparticles self-assemble to form a chiral nematic (cholesteric) phase comprising helical structures (helicoids). Each helicoid may have a random spatial orientation, defined along the helix long axis. Chiral nematic helicoids may be described as pseudo-layered, and this can be seen by hypothetically cutting the helix along its long axis into an infinite number of discrete, thinly-stacked planes parallel to each other. Each pseudo-layer contains nanocrystals pointing in the same average direction. Defined outwards along this direction, the director is a vector rotating around the helix long axis continuously from one pseudo-layer to the other. A full rotation of the director is completed over one helical pitch, which describes the periodicity of the helical stack. The rotation of the mesogens around the helix enables the recovery of their properties every half helical turn. If the mesogens are birefringent molecular constituents, the chiral nematic phase exhibits unique optical properties as the refractive index is modulated periodically, giving rise to light reflection.

CN 113061274 relates to polymorphic multi-structural colour films and a method of preparing the same, comprising drop-casting a cellulose nanocrystal suspension onto a glass substrate, drying to obtain a self-assembled film, coating with an organic amorphous polymer and then curing. However, CN 113061274 does not describe spreading the nanocrystal suspension across the substrate using a spreader or ageing the nanocrystal suspension to partially or completely recover the cholesteric structures lost during deposition and spreading. CN 113061274 does not describe a film having a thickness of 20 μm or less, and also does not describe structurally coloured particles.

US 2010/151159 relates to cellulose nanocrystal films having a non-homogenous structure. The films are formed by evaporating water from a cellulose nanocrystal suspension over 4 to 6 hours using varying temperatures. US 2010/151159 does not describe steps of spreading or ageing the film during preparation of the film. US 2010/151159 also does not describe particles and does not mention dividing the film to form particles.

KR 20210062268 describes coloured cellulose nanocrystal films. The process of preparing the films does not include steps of spreading or ageing the suspension, or annealing the film. KR 20210062268 also does not describe particles and does not describe dividing the film to form particles.

WO 95/21901 describes solid liquid crystal cellulose films prepared from a cellulose nanocrystal suspension. The document does not describe a method of preparing the film which includes steps of spreading or ageing the suspension, or annealing the film. WO 95/21901 also only refers to films or individual cellulose nanoparticles. It does not describe particles having a chiral nematic phase or particles formed from dividing the film.

### Methods

The present invention provides a high-throughput method for producing structurally coloured films of cellulose nanocrystals having high reflectance. Generally, the invention provides a process for producing structurally coloured films, the process comprising the steps of:
a) depositing a nanocrystal suspension comprising cellulose nanocrystals onto a substrate using a coating applicator;
b) spreading the nanocrystal suspension across the substrate using a spreader; and
c) drying the deposited nanocrystal suspension so the nanocrystals self-assemble to form a structurally coloured film.

In a first aspect of the invention, there is provided a process for producing structurally coloured films, the process comprising the steps of:
a) depositing a nanocrystal suspension comprising cellulose nanocrystals onto a substrate;
b) spreading the nanocrystal suspension across the substrate using a spreader;
c) ageing the nanocrystal suspension to partially or completely recover the cholesteric structures lost during deposition and spreading;
d) drying the deposited nanocrystal suspension so the nanocrystals self-assemble to form a structurally coloured film;
e) annealing the structurally coloured film to increase the water resistance of the film.

The final colour of the film can be tuned by, for example, adjusting the properties of the nanocrystal suspension, adjusting the deposition rate, adjusting the spreading (coating) conditions, and by adjusting the drying conditions.

In the coating process, the nanocrystal suspension may be spread across the substrate using a coating applicator or a spreader. The gap between the coating applicator/spreader and the substrate is fixed and is from 5 μm to 5 mm, preferably from 300 to 1500 μm, more preferably 300 to 1100 μm. The term “fixed” here is used to mean that the gap does not change during coating except by interference of the user. That is, the gap does not vary independently in an uncontrolled manner.

The gap between the coating applicator/spreader and the substrate is sometime referred to as the coating gap in the art. A larger gap leads to a thicker layer of the nanocrystal suspension being deposited and spread onto the substrate. The thickness of the nanocrystal suspension layer affects drying time and so affects the self-assembly and final colouration of the dry film. A thinner nanocrystal suspension layer dries more quickly than a thicker nanocrystal suspension layer. The nanocrystals in a thinner layer have a shorter self-assembly time and are likely to have a less vivid colouration.

In the coating process, the coating speed is at least 0.6 mm/s. Coating speed refers to the speed at which the substrate moves relative to the spreader during at least the spreading step.

In the coating process the substrate is kept level during the depositing, spreading and drying steps. The term kept level is used here to refer to substantially the entire surface of the substrate remaining in a substantially horizontal plane during the depositing, spreading and drying steps.

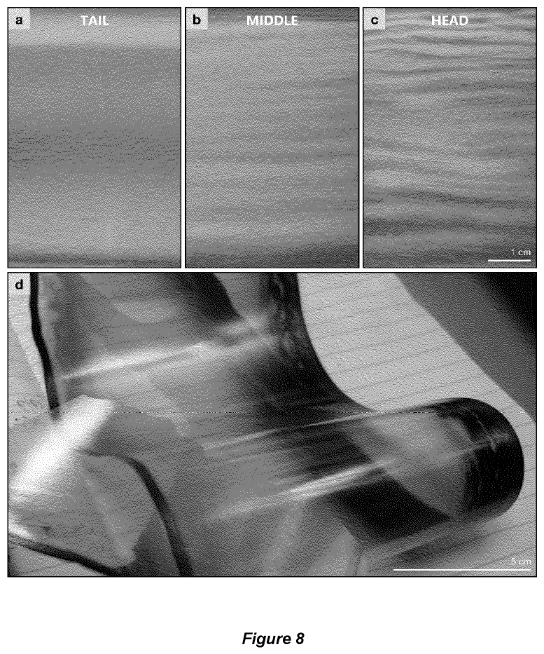

In this way, unwanted flow of the nanocrystal suspension during deposition, spreading and drying is prevented. Unwanted flow of the nanocrystal suspension can result in disturbance of the self-assembly process and therefore reduced ability of the nanocrystals to form the chiral nematic order required for optimal structural colouration. FIG. 8 shows an example of the macroscopic appearance of a coated film when unwanted flow takes place.

The substrate may be kept level by using a rigid substrate, by tensioning the substrate, by supporting the substrate or by any combination thereof.

For example, the rigid substrate may be thick enough not to warp during deposition and spreading. Preferably the rigid substrate is also flexible enough to be carried on the drums of a roll-to-roll printing machine.

For example, the substrate may have a tension of from 10 to 250 N, more preferably from 25 to 125 N and even more preferably from 40 to 90 N. The tension difference between the ends of the web was such so that it exceeds 20 N, more preferably 40 N and even more preferably 60 N. The film tension may be determined by a load cell sensor.

In this way, structurally coloured films may be reliably and reproducibly prepared on large scale using industrially viable methods.

### Coating Process

The method of the invention includes the steps of depositing and spreading a nanocrystal suspension across a substrate. Preferably, the nanocrystal suspension comprises neutralised cellulose nanocrystals.

The nanocrystal suspension may be deposited onto the substrate using a coating applicator. Any suitable coating applicator may be used. Suitable deposition methods include using a printing nozzle, spray head or slot die through which the cellulose suspension can flow in a controllable manner.

The nanocrystal suspension may be spread over the substrate using a spreader. Any suitable spreader may be used. Suitable spreaders include a knife, doctor blade, or a slot die.

The coating applicator and spreader can refer to the same apparatus. For example, when the coating applicator is a slot-die used with a moving belt, the steps of depositing and spreading are both achieved by the slot die. Slot die coating is well known, in particular slot die coating is well known in roll-to-roll printing processes. Preferably, a slot die is used as the coating applicator and spreader.

During spreading, the nanocrystal suspension experiences shear.

The shear rate is calculated according to the following equation:

Shear rate=coating speed/coating gap

In some cases the shear rate during the spreading step is 30.0 s⁻¹ or less, 20.0 s⁻¹ or less, 10.0 s⁻¹ or less, 8.0 s⁻¹ or less, 4.0 s⁻¹ or less, 3.0 s⁻¹ or less, preferably 2.8 s⁻¹ or less and more preferably 2.5 s⁻¹ or less.

In some cases, the shear rate during the spreading step is 0.5 s⁻¹ or more, preferably 1.0 s⁻¹ or more, and more preferably 2.0 s⁻¹ or more.

The shear rate during the spreading step may be selected from a range with the upper and lower limits selected from the values given above. For example, the shear rate during the spreading step may be from 2.0 s⁻¹ to 20.0 s⁻¹, preferably 2.0 s⁻¹ to 2.5 s⁻¹, such as around 2.2 s⁻¹.

The nanocrystal suspension may be deposited in discrete batches. In this case, each discrete batch is spread across the substrate during the spreading step.

Alternatively, the nanocrystal suspension may be deposited continuously. In this case, the nanocrystal suspension is continuously spread across the substrate.

The quantity of nanocrystal suspension deposited per unit area of the substrate (the areal loading) may be of 100 μL/cm² or less, 90 μL/cm² or less, preferably 80 μL/cm² or less and more preferably 60 μL/cm² or less.

The areal loading may be 10 μL/cm² or more, 20 μL/cm² or more, preferably 30 μL/cm² or more, and even more preferably 40 μL/cm² or more.

The areal loading may be selected from a range with the upper and lower limits selected from the values given above. For example, the deposition may be at a rate of from 40 μL/cm² to 60 μL/cm² such as around 50 μL/cm².

The quantity of material deposited per unit time (the deposition rate) may be 12,000 μL/min or less, 10,000 L/min or less, preferably 8,000 μL/min or less and more preferably 6,000 μL/min or less.

The deposition rate may be 800 L/min or more, 1,200 μL/min or more, 1,600 μL/min or more, preferably 2,000 μL/min or more, and even more preferably 2,400 L/min or more.

The deposition rate may be selected from a range with the upper and lower limits selected from the values given above. For example, the deposition may be at a rate of from 2,000 μL/min to 8,000 μL/min such as around 6,000 μL/min.

Typically, the substrate is moved relative to the coating applicator and the spreader. In this way, the nanocrystal suspension can be spread along the substrate by a combination of the spreader and the movement of the substrate.

Coating speed refers to the speed at which the substrate moves relative to the coating applicator or spreader during at least the spreading step.

The coating speed may be at least 1.0 mm/s, at least 1.5 mm/s at least 2.0 mm/s at least 4.0 mm/s preferably at least 1.0 mm/s and more preferably at least 1.5 mm/s.

The coating speed may be 60.0 mm/s or less, 30.0 mm/s or less, 15.0 mm/s or less, 3.0 mm/s or less, preferably 2.7 mm/s or less and more preferably 2.4 mm/s or less.

The coating speed may be selected from a range with the upper and lower limits selected from the values given above. For example, the coating speed may be from 1.0 mm/s to 2.4 mm/s, such as around 1.5 mm/s.

Preferably the coating process is a roll-to-roll printing process. Roll-to-roll printing is a well-known printing technique. Roll-to-roll printing involves the deposition of a substance from a fixed print head onto a moving substrate. Typically, the moving substrate is provided in the form of a roll and is often referred to as a web. The term web refers to a flat, elongated (sometimes continuous) substrate that can be wound and rewound. During printing, the substrate or web is unwound from the roll, a substance is deposited on the unwound portion of the web and the deposited substance is carried on the surface of the substrate or web for further processing, such as drying. The web or substrate may be re-wound to form a second roll, either with or without the deposited substance on the surface of the web. Alternatively, the deposited substance may be removed and the web or substrate continuously recycled in further processing steps (Here, the web or substrate is in the form of a closed loop).

In some cases, the deposition can be performed over one or more discrete areas of the substrate or web.

In the present case, after deposition of the nanocrystal suspension on the web or substrate, the further processing steps include spreading, drying, and optionally removal of the structurally coloured film from the surface of the web or substrate (peeling). Additional pre-treatment steps may also be carried out on the web or substrate prior to deposition of the nanocrystal suspension. The additional pre-treatment and later processing steps are discussed in more detail below.

### Substrate

The substrate is a suitable surface on which the nanocrystal suspension may be deposited, spread and dried.

In some cases the substrate has a thickness of 10,000 μm or less, 1,000 μm or less, preferably 800 μm or less, and even more preferably 500 μm or less.

In some cases the substrate has a thickness of 50 μm or more, 100 μm or more, preferably 300 μm or more, and even more preferably 400 μm or more.

The substrate thickness may be selected from a range with the upper and lower limits selected from the values given above. For example, the substrate thickness may be from 300 to 500 μm such as around 400 μm.

In this way, the substrate is relatively rigid and assists in keeping the substrate uniform and level during deposition and drying.

The substrate may be or comprise any suitable material. Suitable substrate materials include polyvinyl alcohol, cellophane, polystyrene, acetal, ethylene-vinyl acetate, polyethylenes such as polyethylene terephthalate, polypropylene, fluoropolymer; polyimide, nylon, polyester, epoxy resin, acrylic resin, phenolic resin, polycarbonate, polyurethane, polyvinylchloride, and polyester. Preferably the web is polyethylene terephthalate (PET).

The substrate may comprise substantially one suitable material.

Alternatively, the substrate may comprise two or more suitable materials. In such case, the materials may be mixed (blended) together, or they may be combined to form separate domains of each material.

The substrate may be pre-structured, such as micro or nano-structured. In such cases, the substrate may be referred to as “patterned”. This pre-existing patterning can influence the interaction of the deposited substance with the substrate. For example, the substrate may exhibit areas where the deposited nanocrystal suspension can more favorably interact with, or have greater wetting of, the substrate. Similarly, the patterning may provide areas in which the deposited nanocrystal suspension interacts less favorably with, or has poorer wetting or, the substrate such that it preferentially avoids such areas.

The orientation of the cholesteric domains may be altered as a result of the patterning. For example, the orientation may follow the topography of the substrate such that the reflection from the cholesteric domains occurs over a wider range of angles. This can create a more complex visual effect than when a planar substrate with no such pre-existing pattern is used.

After formation of the structurally coloured nanocrystal film, the substrate may be separated from the film. This step may be referred to as peeling, and is discussed in further detail below.

In some cases, the substrate can be reused several times in a closed-loop fashion.

Additionally, in some cases, the substrate is in the form of a moving belt such as a heat resistant moving belt, such as made of metal.

### Nanocrystal Suspension

The method of the invention includes the step of depositing a nanocrystal suspension, such as a cellulose nanocrystal suspension, onto a substrate.

Cellulose nanocrystals (CNCs) are well known in the art. Methods for the preparation of cellulose nanocrystals are also well known in the art. Many types of cellulose nanocrystals are known, and examples includes those cellulose nanocrystals obtained from different biological sources as well as those nanocrystals prepared in different ways from the same source.

The cellulose nanocrystals used in this invention can be any suitable cellulose nanocrystal. The cellulose nanocrystals can be any cellulose nanocrystal able to self-assembled into cholesteric structures.

Cellulose nanocrystals may be prepared from bacterial, vegetal or animal sources (e.g. chitin), including plant-based and biomass source such as cotton and wood and any subsequent processed element coming from such, such as paper, filter-paper cotton linters, and wood pulp.

The processing procedures carried out on the source material in order to produce cellulose nanocrystals typically involve hydrolysis, separation of the hydrolysed compounds and purification. Separation can be performed through centrifugation. Purification can be carried out by dialysis and membrane ultrafiltration. Known methods for producing cellulose nanocrystals are described by Lagerwall et al. (NPG Asia Materials 2014, 6, e80), the contents of which are hereby incorporate by reference.

Typically, the cellulose source is hydrolyzed, such as with sulfuric or hydrochloric acid or other acids, or alkaline medium in the preparation process, or the cellulose source is oxidized, such as in the case of the preparation of TEMPO-oxidized cellulose nanocrystals. Preferably, the nanocrystal solution comprises pH-neutralized cellulose nanocrystals. More preferably, the nanocrystal solution comprises the sodium form of cellulose nanocrystals.

During hydrolysis, it is proposed that the cellulose chain backbone of the cellulose nanocrystals are modified at the molecular level to provide colloidal stability to the nanocrystals. For example, sulfuric acid hydrolysis is thought to modify the cellulose chains with sulfate half ester groups. Another example of alteration occurs during extraction with hydrogen peroxide, in which the cellulose chains are thought to be modified with carboxylic groups, providing carboxylate cellulose nanocrystals. As a result of the modification of the cellulose chains with charged groups, several counter ions can be used to balance the charges. Most commonly, H+ (to give acidic-form cellulose nanocrystals) and Na⁺ (to give neutralized (e.g. sodium form) cellulose nanocrystals. Counter ions (e.g. H⁺) may be exchanged in suspension, for example by using concentrated NaOH or NaCl solution to give fully or partially neutralized cellulose nanocrystals. Na+ can be exchanged in suspension similarly, for example by using concentrated HCl or H₂SO₄.

Preferably, the nanocrystal suspension comprises pH-neutralized cellulose nanocrystals, partially pH-neutralized cellulose nanocrystals or acidic-form cellulose nanocrystals. More preferably, the nanocrystal suspension comprises the sodium form of cellulose nanocrystals.

In the present case, the preparation of the cellulose nanocrystal suspension may include sonication of the cellulose nanocrystal suspension.

A cellulose nanocrystal is typically rod-shaped. Thus, the crystal may be elongate with a length dimension considerably greater than the width dimension.

A cellulose nanocrystal for use in the present case may have a length that is at most 200, at most 500, at most 1,000, or at most 1,500 nm.

The cellulose nanocrystal for use in the present case may have a length that is at least 50, at least 70, or at least 100 nm.

The cellulose nanocrystal for use in the present case may have a width that is at most 20, at most 30, at most 50 nm.

The cellulose nanocrystal for use in the present case may have a width that is at least 1, at least 3, at least 5, or at least 10 nm.

The aspect ratio for the cellulose nanocrystal may be at least 5, 7, 10, 15 or 20.

The aspect ratio for the cellulose nanocrystal may be at most 40, 50, 100, 150 or 200.

The cellulose nanocrystals can be provided as a suspension, e.g. in a solvent, or as a powder, such as a spray-dried or freeze-dried powder. Such powders are redispersed to provide the cellulose nanocrystal suspension used in the present invention.

Any suitable solvent may be used, such as any solvent in which the cellulose nanocrystals can form a colloidally stable suspension, with or without the use of additive such as a surfactant. Suitable solvents includes: water, acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethylene glycol, diethyl ether, diglyme (diethylene glycol, dimethyl ether), 1,2-dimethoxy-, ethane (glyme, DME), dimethyl-, formamide (DMF), dimethyl sulfoxide (DMSO), 1,4-dioxane, ethanol, ethyl acetate, ethylene glycol, glycerin, heptane, hexamethylphosphoramide, (HMPA), hexamethylphosphorous, triamide (HMPT), hexane, methanol, methyl t-butyl, ether (MTBE), methylene chloride, N-methyl-2-pyrrolidinone, (NMP), nitromethane, pentane, petroleum ether (ligroine), 1-propanol, 2-propanol, pyridine, tetrahydrofuran (THF), toluene, triethyl amine, o-xylene, m-xylene, p-xylene or ionic liquids.

Preferably the solvent is water.

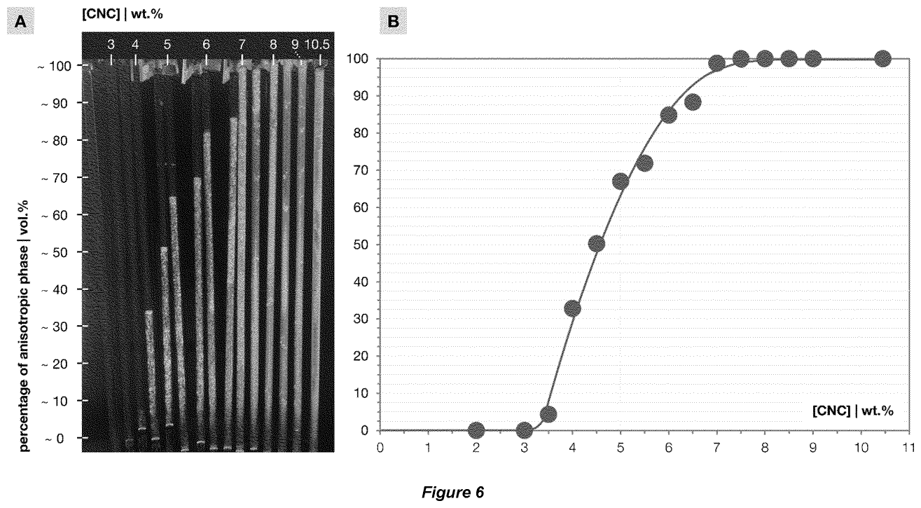

An increase in the concentration of the cellulose nanocrystals in the suspension may be associated with an increase in anisotropy of the suspension. Conversely, a decrease in the concentration of the cellulose nanocrystals in the solvent may be associated with a decrease in anisotropy in the suspension. For example, the cellulose nanocrystal suspension used in the worked examples show complete anisotropy in water at around 7 wt % and above (FIG. 6). Complete loss of anisotropy is seen at around 3.5 wt % and below.

Preferably, the concentration of the cellulose nanocrystals in the suspension is chosen to provide a mixture which has at least some anisotropy, for example in the form of chiral nematic structure. The present inventors have found that the use of nanocrystal mixtures, such as aqueous suspensions, where the suspension is in a liquid crystalline state with no, very low or partial anisotropy (e.g. a biphasic state) does not provide films having optimal colouration of high quality. It is proposed that such films have inhomogeneities which provide the poorer colouration properties observed.

Typically, the nanocrystal suspension comprises cellulose nanocrystals (such as neutralised cellulose nanocrystals) at a concentration of at most 12 wt %, preferably at most 11 wt %, more preferably at most 10 wt %, even more preferably at most 9 wt %, and most preferably at most 8 wt %.

Typically, the nanocrystal suspension comprises cellulose nanocrystals (such as neutralised cellulose nanocrystals) at a concentration of at least 1.5 wt %, preferably at least 2 wt %, more preferably at least 3 wt %, even more preferably at least 4 wt %, and most preferably at least 5 wt %.

The nanocrystal suspension may comprise cellulose nanocrystals in a range with upper and lower limits selected from the values given above. Typically, the nanocrystal is present in the mixture in an amount selected from 4 to 12 wt %, preferably from 4 to 8 wt %, more preferably from 6 to 8 wt %.

The wt % values that are chosen will depend upon the level of anisotropy that results from the use of a given cellulose nanocrystal and can be appropriately chosen.

Additionally or alternatively, the amount of nanocrystal used may be expressed in terms of the level of anisotropy within the nanocrystal suspension.

The nanocrystal may be present in a mixture where the level of anisotropy is at least 10, 15, 20, 25, 30, 35, 40, 45, 50, 55, 60, 65 or 70%. Additionally, or alternatively, the nanocrystal may be present in a mixture where the level of anisotropy is at most 65, 70, 75, 80, 85, 90 or 95%. The nanocrystal may be present where the mixture is substantially all anisotropic (substantially 100% anisotropy).

The nanocrystal may be present in the mixture where the level of anisotropy selected from a range with the upper and lower limits selected from the values given above. For example, nanocrystal may be present in the mixture where the level of anisotropy is selected from 25 to 100%.

In the case where a sonication step is performed before the deposition step, the anisotropy refers to the anisotropy of the cellulose nanocrystal suspension before the sonication.

Sonication can alter the level of anisotropy in the suspension. In some cases, it may be preferable to discard the non-anisotropic portions of the suspension.

Other components may be present with the cellulose nanocrystal or added to the cellulose nanocrystal suspension to alter the self-assembly properties of the cellulose nanocrystals, and/or the physical and chemical properties of the cellulose nanocrystals, the nanocrystal suspension, and/or structurally coloured film. For instance, additives, particularly polymers, functional molecules, and filler may be included, which can act as rheology modifiers, plasticizers, thickeners or reinforcing agents to provide additional functionality such as increased flexibility or strength to the structurally coloured films as required. Examples of suitable additives are listed below.

Suitable acids include both organic and mineral acids, and their corresponding salt forms. Suitable organic acids include carboxylic acids their corresponding acid anhydrides, such as the non-phenolic organic acids 2,5-furandicarboxylic acid, acetic acid, adipic acid, ascorbic acid, benzoic acid, boric acid, carbonic acid, citric acid, formic acid, fumaric acid, lactic acid, itaconic acid, levulinic acid, malic acid, oxalic acid, propionic acid, succinic acid; and the phenolic organic acids benzoic acid, cafeic acid, ferulic acid, gallic acid, gentisic acid, parahydroxybenzoic acid, paracoumaric acid, protocatechic acid, vanillic acid, salicylic acid, sinapic acid, syringic acid, phenol acid. Additionally, uric acid may also be used. Suitable mineral acids include hydrochloric acid, chloroacetic acid, hydrobromic acid, bromoacetic acid, hydrochloric acid, hydrofluoric acid, hypobromous acid, hypochlorous acid, hypoiodous acid, iodic acid, iodoacetic acid, nitric acid, perchloric acid, phosphoric acid, phosphorous acid, selenic acid, sulfurous acid, sulfuric acid, telluric acid, tribromoacetic acid, trichloroacetic acid, trifluoroacetic acid. The acid forms corresponding to the bases listed below may also be used. Mixtures of acids may also be used.

Suitable bases include amines, amides, alkaline salts such as sodium acetate, sodium amide, 3-amino-3-methylpentane, ammoniac, aniline, azetidine, bromopyridine, butyl lithium, cadaverine, 2-chlorophenol, 3-chlorophenol, 4-chlorophenol, choline, cyclohexylamine, lithium diethylamide, diethylamine, diisopropylamine, dimethylamine, 2,4-dimethylimidazole, 1,2-dimethylaminoethane, 1,2-dimethylpyrrolidine, ethylamine, ethanediamine, ethanolamine, sodium ethanoate, potassium ethanoate, ferrous and ferric hydroxide, examethylenediamine, hexylamine, hydrazine, sodium hydride, barium hydroxide, calcium hydroxide, iron hydroxide, lithium hydroxide, magnesium hydroxide, potassium hydroxide, sodium hydroxide, hydroxylamine, methylamine, 2-methyl-2-butanamine, 3-methyl-1-butanamine, methylglycine, 1-methylpiperidine, monoethanolamine, n-butylamine, nitrophenols, N-methylpyrrolidine, N-methylpyridinamine, 3-pentanamine, pentylamine, piperidine, propylamine, 1,3-propanediamine, 4-pyridinamine, pyridine, pyrrolidine, sec-butylamine and tert-butylamine, and triethylamine. The alkanaline forms corresponding to the acid previously listed may also be used. Mixtures of bases may also be used.

Suitable salts include neutral salt such as sodium chloride, potassium chloride, ferrous and ferric chloride. Ionic liquids, in which the nanocrystals can be suspended, may also be used. Mixtures of salts may be used.

Suitable polymers include polyethylene glycol, polyethylene imine, polyethylene oxide, polyvinyl alcohol, quaternary polyamines, polyacrylamides, polyacrylic acid and its copolymers, polyacrylates including sodium polyacrylate, dicyandiamide resins, polyvinylpyrrolidone, sodium polystyrene sulphonate, sodium polyvinyl-sulphonate, polyamidoamines, carboxypolymethylene, polyvinyl methyl ether-maleic anhydride; polyols such as polyether polyol and polyester polyol; cellulose derivative such as cellulose nanofibers, microfibrillated cellulose, calcium carboxymethyl cellulose, carboxymethyl cellulose acetate butyrate, carboxymethyl hydroxyethylcellulose, cellulose, cellulose acetate, cellulose acetate butyrate, cellulose gum, cellulose acetate propionate, cellulose acetate propionate carboxylate, cellulose succinate, cetyl hydroxyethylcellulose, ethylcellulose, hydrolyzed cellulose gum, hydroxybutyl methylcellulose, hydroxyethylcellulose, hydroxyethyl ethylcellulose, hydroxypropylcellulose, hydroxypropyl methylcellulose, hydroxypropylmethylcellulose acetate/succinate, hydroxypropyl methylcellulose phthalate, methylcellulose, methyl ethylcellulose, methyl hydroxyethylcellulose, microcrystalline cellulose, potassium cellulose succinate, sodium cellulose sulfate, nitrocellulose, cellulose acetate, rayon, regenerated cellulose, cellulose acetate-propionate, cellulose acetate-butyrate, cellulose triacetate, viscose; other polysaccharides, glucose and polysaccharide derivatives such as arabinoxylans, carrageenan, chitin, chitosan, fucoidan, galactogen, galactomannan, glucans, glycogen, inulin, lignin, mannan, pectins, starch and xylans. In addition to the polysaccharides listed above, sulfated and oxidized polysaccharides may also be used. In addition to the cellulose derivatives listed above, hemicelluloses may also be used. Mixtures of polymers may be used.

Suitable functional molecules include monosaccharides such as arabinose, deoxyribose, erythrose, fructose, galactose, glucose, and sorbose; sugar alcohol and polyols such as arabitol, cyclitols such as pinitol, ethylene glycol, erythritol, galactitol, glycerol, isomalt, lactitol, maltitol, mannitol, pentaerythritol sorbitol and xylitol; proteins such as collaged, gelatin and sericin; and aminoacids. Small molecules also include dyestuff such as acid dyes, basic dyes, direct dyes, sulphur dyes, vat dyes, reactive dyes and azoic colorants.

Additionally, the dye stuff may be a black dye, or may result in a black appearance. Mixtures of functional molecules may be used.

Suitable fillers include water-soluble inorganic material and nano-objects such as clays, including hectorite, kaolin, mica, montmorrilonite, laponite, cloisite; carbon materials, such as carbon nanotubes, graphite, graphene, carbon black; and water-soluble proteins such as albumins, whey, plant-derived proteins and zein. Mixtures of functional fillers may be used.

Additionally, typical fillers include water-soluble inorganic material, micro-materials and nano-objects such as clays, including hectorite, kaolin, mica, minerals, oxides, montmorrilonite, laponite, cloisite; carbon materials, such as carbon nanotubes, graphite, graphene, carbon black; and water-soluble proteins such as albumins, whey, plant-derived proteins, and zein. In addition, typical fillers include organic and inorganic pigments such as aluminum, copper, cobalt, gold, iron, manganese, cadmium, chromium, arsenic, bismuth, chromium, lead, titanium, barium, tin, zinc, cerium, mercury, carbonaceous, antimony based pigments; fluorescent pigments.

Further modifications to the cellulose nanocrystals, and to the compounds used in the preparation of the cellulose nanocrystals, are described in the art. Such modification is typically made with a view to maintaining the ability of the cellulose nanocrystal to form a chiral nematic phase.

### Ageing

The method of the invention includes an ageing step. During the ageing step, the nanocrystal suspension partially or completely recovers any cholesteric structures lost during deposition and spreading.

In this way, the optical properties of the resulting film can be optimised. Without wishing to be bound by theory, it is proposed that high shear during spreading can disrupt pre-existing chiral nematic ordering and result in poorer optical properties. If any disruption of any anisotropy in the nanocrystal suspension resulting from excessive shear rate occurs, any pre-existing chiral nematic ordering can be recovered, partially or fully, by lengthening the ageing time, as the dissipation of the alignment is a thermodynamically favoured process. In addition, nanocrystal suspensions having a lower viscosity permit a return to equilibrium with a short relaxation time. As such, nanocrystal suspension having a relaxation time of 30 minutes or less are preferred.

Typically, the deposited nanocrystal suspension is aged for 360 minutes or less. Preferably, the nanocrystal suspension is aged for 120 minutes or less, more preferably 60 minutes or less, even more preferably 45 minutes or less, and most preferably 30 minutes or less.

Typically, the deposited nanocrystal suspension is aged for 1 minute or more, 5 minutes or more. Preferably, the nanocrystal suspension is aged for 10 minutes or more, more preferably 15 minutes or more, and even more preferably 20 minutes or more.

The time for the ageing step may be selected from a range with upper and lower limits selected from the values given above. For example, the deposited nanocrystal suspension may be aged for from 5 to 120 minutes, preferably 5 to 30 minutes.

The ageing step may be carried out as a pause before any further processing steps. Alternatively, the ageing step may be carried out simultaneously with the drying step, for example, by extending the drying time.

During the ageing step, the partial or total recovery of the chiral nematic ordering in the applied nanocrystal suspension can be facilitated throughout the deposited nanocrystal suspension or locally, by an external electromagnetic field.

### Drying

The method of the invention includes a drying step for drying the deposited nanocrystal suspension to form a structurally coloured film.

Drying may be concurrent with the previously described ageing step.

The drying step may be carried out at room temperature without external heating.

Typically, however, the drying step is carried out at elevated temperature.

The drying step may be carried out at a temperature of 250° C. or less, 150° C. or less, 100° C. or less, preferably 80° C. or less, and even more preferably 70° C. or less.

The drying step may be carried out at a temperature of 10° C. or more, 20° ° C. or more, 30° C. or more, preferably 40° C. or more, and even more preferably 50° C. or more.

The temperature of the drying step may be selected from a range with the upper and lower limits selected from the values given above. For example, the temperature of the drying step may be from 10 to 70° C. such as around 60° C.

The temperatures of the drying step may be selected based on the solvent mixture used in the nanocrystal suspension. Preferably, a temperature is used at which the solvent mixture is not boiling or near boiling.

In this way, the film produced may have the desirable coloration properties. It is proposed that, when the solvent mixture is boiling or near boiling the increased movement of the solvent and gas bubble formation may disturb the chiral nematic structures and create inhomogeneities in the final dry film.

The drying step may be carried out such that the dried film is formed in 720 minutes or less, 360 minutes or less, 120 minutes or less, 60 minutes or less, preferably 45 minutes or less, and even more preferably 30 minutes or less.

The drying step may be carried out such that the dried film is formed in 10 minutes or more, preferably 15 minutes or more, and even more preferably 20 minutes or more.

The time for the drying step may be selected from a range with the upper and lower limits selected from the values given above. For example, the drying step may be carried out such that the dried film is formed in 10 to 60 minutes such as around 30 minutes.

The combination of drying time and temperature will depend on the coating gap, coating speed and width, and thickness of the deposited suspension. For thicker deposited suspensions (i.e. larger gaps), longer drying times will be observed at the same temperature than for a thinner deposited suspension (i.e. smaller gaps).

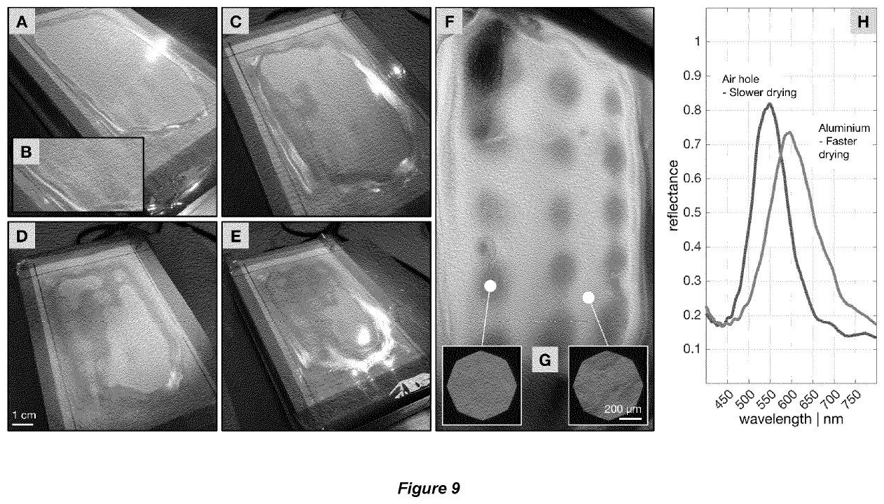

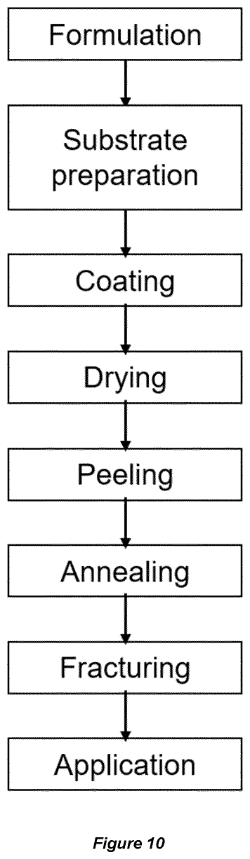

Time constrained drying, for example short drying times with respect to the amount of cellulose nanocrystal suspension deposited, affects the colouration of the resulting film, in particular the reflectance of the film. Without wishing to be bound by theory it is proposed that time-constrained evaporation such as during heating induces less homogeneous and more disordered films. Disorder can result from chiral nematic domains that became kinetically arrested in random orientation and non-optimal compression of the domains upon drying as it has been described in the literature (see for instance Parker, R. M. et al. Adv. Mater. 30, 1704477 (2018)). It is also proposed that heating results in more significant flow of solvent and compounds within the cellulose nanocrystal suspension due to, for example, temperature or concentration gradient that disturb the cellulose nanocrystal suspension. Overall, such effect means that the reflectance peak decreases and a redshift of the peak can be observed (see FIG. 9).

In some cases, the dried film has a thickness of at least 1.0 μm, 2.0 μm, at least 3.0 μm, at least 4.0 μm, at least 5.0 μm, at least 6.0 μm, at least 7.0 μm, at least 8.0 μm, or at least 9.0 μm.

In some cases, the dried film has a thickness of 50.0 μm or less, 30.0 or less, 20.0 or less, 17.0 or less, 15.0 or less, 12.0 μm or less, 10.0 μm or less.

The film thickness may be selected from a range with the upper and lower limits selected from the values given above. For example, the film thickness may be from 1.0 to 50.0 μm, such as from 6.0 μm to 12.0 μm, such as around 9.0 μm.

The drying step may be carried out uniformly across the width of the film. Alternatively, the drying conditions may be locally varied (FIG. 9).

The drying is carried out with any suitable drying apparatus. Suitable drying apparatus include an IR or UV radiation lamp, a hot air drier, an oven, a convection oven, a furnace, a vacuum oven and a hot plate. Combinations of drying steps using different apparatus may be used, either successively or simultaneously.

### Treating

In some cases, the method further comprises a treating step wherein at least a portion of the substrate is treated to modify the physical and/or chemical properties of the substrate prior to the depositing step.

The treatment step may impart beneficial properties to the substrate, such as enabling easier and more uniform deposition and spreading of the nanocrystal suspension over the substrate, improved optical properties of structurally colored film, an increased yield of the film, and therefore a corresponding increased yield of structurally coloured particles per area of substrate used.

Typically, the treating step alters the surface energy of the substrate, for example by corona discharge or plasma etching. Preferably the treatment step comprises subjecting the substrate to corona discharge or plasma etching, more preferably corona discharge.

Preferably, a material with a lower surface energy can be treated to increase its surface energy. Lower surface energy materials include polyvinyl alcohol, cellophane, polystyrene, acetal, ethylene-vinyl acetate, polyethylenes such as polyethylene terephthalate (PET), polypropylene, fluoropolymer, polyimide, nylon, polyester, epoxy resin, acrylic resin, phenolic resin, polycarbonate, polyurethane, polyvinylchloride, polyester.

In the case of the treatment of material with a lower surface energy, it is proposed that increasing the surface energy of the substrate reduces the surface tension when the nanocrystal suspension is deposited. The treatment is such that the deposited nanocrystal suspension preferentially coats the substrate at the area that has been treated. For example, when the substrate is PET treatment by corona discharge, means the treated area of the web is more hydrophilic and aqueous suspensions will preferentially coat this hydrophilic surface.

In this way, the treating step results in a specific and localized surface activation that gives areas with different wetting properties and allows to control the deposition of the suspension to either the treated or non-treated parts of the substrate.

In some cases, the method may comprise a treating step wherein at least a portion of the substrate is treated to decrease the surface energy prior to the depositing step. Suitable methods that can lead to the modification of the chemistry of the surface and to decrease the surface energy of the substrate include chemical and oxidative treatments or alteration of surface roughness through sanding or laser ablation for instance.

Preferably, a material with a higher surface energy can be treated to decrease its surface energy. Higher surface energy materials include metals, such as copper, aluminium, zinc, tin, stainless steel and their alloys and glass.

In some cases, the treatment can be carried out such that the surface energy of the substrate varies locally. The local variations in surface energy may be in the form of a pattern.

Typically, the treating step is carried out on the central portion of the substrate. Preferably, the edges of the web surface may be masked before treatment such that the treatment is applied only to a preferred area, most preferably to the central portion of the web or substrate. The masking is typically removed before deposition of the nanocrystal suspension. In this way, the deposited suspension preferentially coats the central portion of the substrate and is prevented from flowing off the web by the untreated (i.e. previously masked) edge portions.

In some cases, the treatment step is carried out on pristine substrate. Alternatively, the treatment step may be carried out to reinforce pre-existing surface energy properties of the substrate, particularly in the case of a substrate used in a closed loop fashion.

The treating step may be carried out in air, oxygen or argon rich atmosphere, under reduced pressure or ambient pressure. Preferably such treatment is performed in air and at ambient pressure.

### Sonication

The method of the invention may further comprise the step of sonicating the nanocrystal suspension before the depositing step.

Sonication, such as tip-sonication, of the nanocrystal suspension before deposition may be used to alter, such as red shift, the final colour of the dry nanocrystal film. It is proposed that sonication acts to expand the pitch of the chiral nematic phase resulting in a redshift, although the exact mechanism for this is not clearly identified and may involve a reduction of the size of the nanocrystal and possible release of trapped ions.

The sonication energy delivered may depend on the device used, the power and amplitude delivered, and the volume of cellulose nanocrystal suspension as well as the concentration nanocrystals in the suspension. Suitable sonication devices are known in the art, and the power, amplitude and time can be appropriately adjusted.

The length of time over which sonication is performed may be altered, and longer times may be used for the sonication of larger quantities of material. For the purpose of comparing sonication treatment between samples regardless of the quantity of material being sonicated, the sonication treatment is commonly expressed in Joules per mass (J/g), for example Joules per mass of cellulose nanocrystals in the cellulose nanocrystal suspension (J/g_{CNC}). The sonication treatment can also be expressed in second of treatment per millilitre of cellulose nanocrystal suspension (s/mL). While both units are used, the second unit may be preferred as it can be directly calculated from the input parameters.

The sonication step may be performed for 45 s/mL or less, such as 22.5 s/mL or less, preferably 11.2 s/mL or less, or more preferably 6.7 s/mL or less.

The sonication step may be performed for at least 0.1 s/mL, at least 0.5 s/mL, at least 1 s/mL, at least 2.2 s/mL, at least 22.5 s/mL preferably at least 0.2 s/mL or more preferably of at least 1 s/mL.

The sonication step may be performed for a time per millilitre of suspension selected from a range with the upper and lower limits selected from the values given above. For example, the sonication step may be performed for from 0.1 to 45 s/mL, such as around 2.2 s/mL.

The sonication step may deliver to the nanocrystal suspension an energy of 200 KJ/g or less, 100 KJ/g or less, preferably 50 KJ/g or less, or more preferably 30 KJ/g or less.

The sonication step may deliver to the nanocrystal suspension an energy of at least 3 J/g, at least 5 KJ/g, at least 10 KJ/g, at least 100 KJ/g preferably at least 3 KJ/g or more preferably of at least 5 KJ/g.

The sonication step may deliver to the nanocrystal suspension an energy selected from a range with the upper and lower limits selected from the values given above. For example, the sonication step may deliver to the nanocrystal suspension an energy may be from 1 to 100 KJ/g, such as around 10 KJ/g.

The sonication step may be performed for 2,000 seconds or less, 1,000 seconds or less, 500 seconds or less, 400 seconds or less, preferably 300 seconds or less and more preferably 200 seconds or less.

The sonication step may be performed for 20 seconds or more, 30 seconds or more, preferably 40 seconds or more and more preferably 50 seconds or more.

The sonication step may be performed for a duration from a range with the upper and lower limits selected from the values given above. For example, the sonication step may be performed for from 20 to 2,000 seconds, such as around 200 seconds.

Sonication results in a colour shift of the film prepared from the sonicated nanocrystal suspension. Increasing the sonication energy increases the red shift in the coloured film.

Sonication in the prior art is usually performed on isotropic suspension at around 2 wt % nanocrystals. In the present case, the preferred nanocrystal suspensions contain at least 4 wt % nanocrystals and have some anisotropy.

### Peeling

The method of the invention may further comprise the step of peeling the structurally coloured film from the substrate. The peeling step occurs after the drying step. Preferably the peeling step is carried out on a dry substrate. The peeled film may be transferred to a different substrate, or can be used as a standalone film.

In this way, after peeling, the substrate can be re-used, for instance in a close loop fashion instead of being rewound, to allow for continuous printing.

In some cases, the substrate may be in the form of a moving belt such as a heat resistant moving belt, such as made of metal. The term belt here refers to a closed loop form of the substrate.

In some cases, the edges of the structurally coloured film are removed after the peeling step.

### Dividing

The method of the invention may further comprise the step of dividing the structurally coloured film to produce structurally coloured particles. In the dividing step, the dimensions of the structurally coloured film is reduced to provide particles that can be used as pigment or glitter. The present invention also provides structurally coloured particles obtained or obtainable by the method of the invention.

The coloured particles maintain the colour from the film and have an appearance that is similar to glitters such as microplastic glitters and effect pigments such as mica- and titania-based effect pigments. Most glitters available on the market are obtained via the roll-to-roll deposition of a dye-containing synthetic polymer matrix over a metal-based reflective substrate and as such are not biodegradable. In this way, the present invention provides a biodegradable glitter and photonic effect pigment.

Dividing can be performed using any suitable fracturing or chopping apparatus, such as a device using rotating blades, as well as any suitable grinding apparatus, such as a device using grinding elements and high intensity shocks (for instance a mill such as a ball mill, a rusher, a pulveriser, or a cryogrinder). A die- or laser-cutter may also be used to reduce the dimensions of the film and yield particles with a defined shape.

Preferably, a fracturing apparatus is used. In such cases, the dividing step may be referred to as a fracturing step.

Alternatively, a grinding apparatus is used. In such cases, the dividing step may be referred to as a grinding step.

In some case, a fracturing and a grinding apparatus are successively used. In such cases, fracturing provides larger particles which can be broken down into smaller particles through separate grinding for production of particles with specific sizes in specific yield.

The dividing step preferably occurs after a peeling step. In this way, the substrate is not damaged during the dividing and is not incorporated into the coloured particles, and so does not contribute to the thickness of the particles.

Without wishing to being bound by theory, it is understood that the structurally coloured film breaks at cholesteric domain boundaries as the nanocrystals are expected to be less ordered at the boundaries between domains in comparison to within cholesteric domains. However, fractures and cracks may propagate through cholesteric domains upon high intensity dividing.

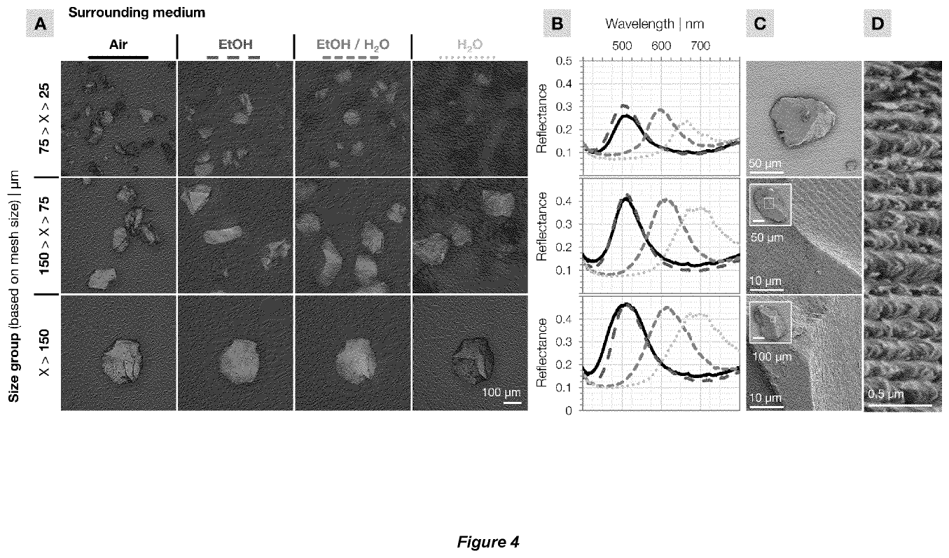

After dividing, the optical properties of the structurally coloured film are retained (FIG. 4).

The structurally coloured particles may be sorted by size to obtain particles of the desired diameter or surface area. The size sorting can be carried out during fracturing and/or grinding for example when dividing is carried out with an ultracentrifugal mill. The size sorting can be carried out after fracturing and/or grinding, for example, by sieving. Particles with larger sizes (e.g. larger median average diameter or average surface areas) have improved optical properties compared to particles with smaller sizes (FIG. 4). That is, they have a narrower and/or taller reflection peak.

The structurally coloured particles are suitable for use as effect pigments, such as interference, metallic and pearlescent pigments and glitters due to their ability to reflect light and provide structural colour, including visible, infrared and ultraviolet colour.

The structurally coloured particles may be used as such pigments and glitters, or dispersed in a solvent or other formulation depending on their intended use. For example, the particles may be used in cosmetics, foodstuffs, packaging, or in paints. Preferably the solvent for the selected application is water, glycerol, ethanol or a mixture thereof. Mixtures of these components with oils may be used, and such mixtures may also contain a surfactant.

### Annealing

The method of the invention may further comprise the step of annealing the structurally coloured film or the structurally coloured particles. Typically, the anneal step is carried out on the structurally coloured film. Here, the annealing step is carried out after the drying step and before the dividing step, if present.

The annealing step refers to a step of heating the structurally coloured film. Without wishing to be bound by theory, it is proposed that annealing removes tightly-bound water molecules and promotes destabilization of the sulphate half ester groups covering the surface of the cellulose nanocrystals, therefore becoming reactive. It is proposed that the removal of water and desulfation promotes the formation of new molecular bonds between adjacent nanocrystals. As a result, water molecules are less prone to interact with the chains and to penetrate the nanostructure, preventing the swelling and disintegration of the particles in water from occurring.

The annealing step may lead to oxidation, polymerisation and crosslinking between the cellulose nanocrystals and any additional compounds or additives that remain in the film after the drying step.

The annealing is carried out with any suitable apparatus able to heat, oxidize, polymerise, crosslink the cellulose nanocrystals and any additional compounds or additives that remain in the film as well as removing tightly-bound water molecules and destabilizing the sulphate half ester groups covering the surface of the cellulose nanocrystals. Suitable drying apparatus include an IR or UV radiation lamp, a furnace, a hot air drier, an oven, a convection oven, a vacuum oven and a hot plate. Combinations of drying steps using different apparatus may be used, either successively or simultaneously.

The temperature of the annealing step may be 250° C. or less, 230° C. or less, preferably 220° C. or less, and more preferably 190° C. or less.

The temperature of the annealing step may be 100° C. or more, 110° C. or more, preferably 140° C. or more, and more preferably 170° C. or more.

The temperature of the annealing step may be selected from a range with the upper and lower limits selected from the values given above. For example, the temperature of the annealing step may be from 100 to 250° C., preferably from 140 to 220° C.

The annealing step may be carried out for 120 minutes or less, 60 minutes or less preferably 40 minutes or less, and more preferably 30 minutes or less.

The annealing step may be carried out for 2 minutes or more, 5 minutes or more, 10 minutes or more, preferably 15 minutes or more, and more preferably 20 minutes or more.

The annealing step may be carried out for a time selected from a range with the upper and lower limits selected from the values given above. For example, the annealing step may be carried out at for from 10 minutes to 120 minutes, preferably from 20 minutes to 40 minutes such as for around 30 minutes.

The annealing step has the effect of making the structurally coloured particles prepared from the annealed film ‘colourfast’ when they are placed in various solvents, particularly aqueous solvents. The term ‘colourfast’ here refers to the ability of the particles to maintain some colour when suspended in a solution or embedded in a matrix, such as a polymer. Thus, the annealing step reduces and/or inhibits processes such as swelling or disintegration of the structurally coloured films or particles by modifying the physical and/or chemical properties of the nanocrystals.

It is also proposed that annealing prevents the film surfaces from degrading, such as through physical abrasion, during a subsequent dividing step, and FIG. 4 shows the scanning electron microscopy (SEM) top and cross-section views of particles produced from annealed and ground films. These SEM images show that neither the particle surfaces nor the cholesteric structure are significantly damaged suggesting the film structure is not undesirably degraded during the dividing step. This lack of degradation is further supported by the optical performance of the particles, which is similar to the film from which they are derived. Additionally, the particles possess distinct facets with sharp edges: these multiple facets suggest the preferential breaking of the film along defects within the film and very likely between neighbouring chiral nematic domains.

Preferably, when the annealing step is carried out the nanocrystal is a cellulose nanocrystal such as a sodium form cellulose nanocrystal.

In this way, the annealing process results in improved optical properties of the annealed film and any resulting particles produced therefrom. It is proposed that Na⁺ counterions in the cellulose nanocrystals do not catalyse the destabilization of the sulphate half esters upon heating as much as in the case of H⁺ counterions. Excessive destabilization of the sulphate half esters, as typically observed in the case of H+ counterions in the form of strong darkening of the film, is proposed to reduce the optical quality of the cellulose nanocrystal structures.

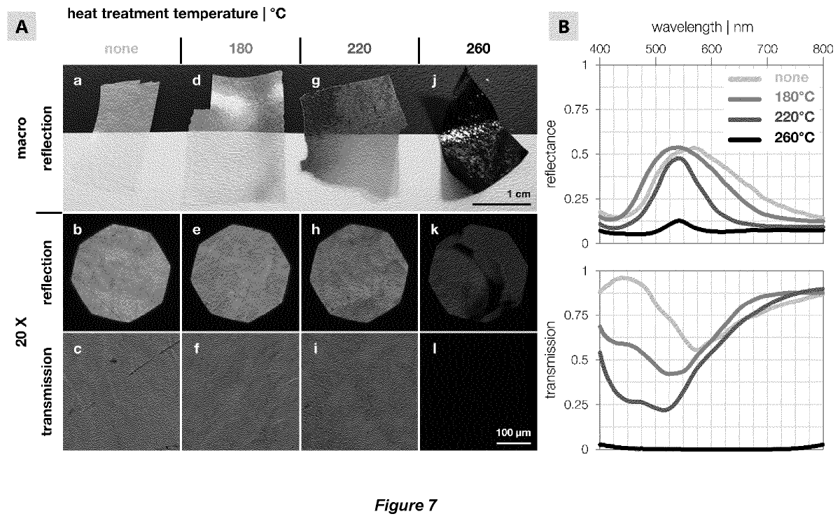

Additionally, as FIG. 7 shows, the annealing step may decrease the transmittance of the film and therefore of an increased opacity of the film. Increased opacity may improve the colour contrast of the film and particle. As such, it is possible to further control the degree of decrease of transmittance and darkening of the particles by carefully controlling the temperature and duration of the heat-treatment step.

The annealing step may decrease the transmittance of the film in comparison to an untreated film by at least 1%, at least 10%, at least 25%, at least 50%.

The annealing step may decrease the transmittance of the film in comparison to an untreated film by no more than 90%, preferably no more than 75%.

The parameters of the annealing step may be carried in such way that the decrease of the transmittance of the film compared with an untreated film falls within the range with the upper and lower limits selected from the values given above. For example, the decrease of the transmittance of the film may be of 33%.

The transmittance of the film may be determined using standard techniques. For example using an optical microscope coupled with a spectrometer, used in bright field imaging configuration. The transmittance values are measured against total transmission. The background noise is subtracted. The reflectance values are measured in the visible range (300 nm to 800 nm). Typically, the samples are mounted flat on the stage of the microscope such that the light rays can be considered to travel perpendicular to the sample's surface to measure reflection at normal incidence, with the light being collected within the cone (numerical aperture) of the objective (maximal reflectance). Typically, the reflectance values are measured in air.

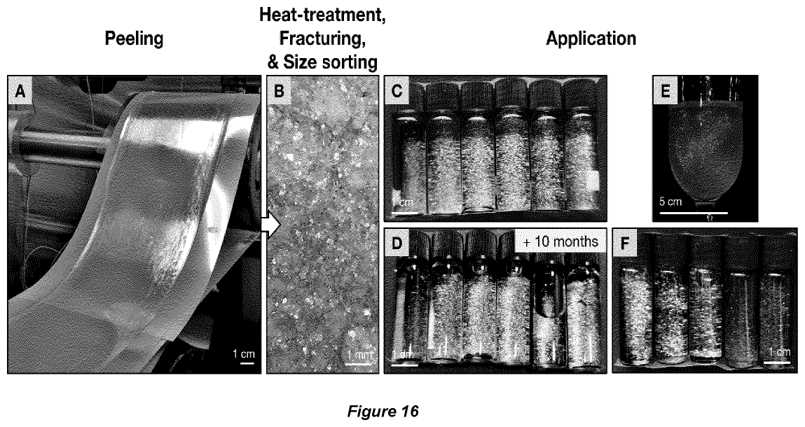

As a result of the annealing step, the film and particles can retain their integrity when placed in water and other solvent for more than 1 year without disintegrating (FIG. 16), while only a limited redshift of the colour of the structurally coloured film and particle may be observed in aqueous solvent.

### Cholesteric Structure and Structural Colour

In a further aspect, the present invention provides structurally coloured films and particles comprising nanocrystals, preferably cellulose nanocrystals. Typically, the structurally coloured film or particle composes neutralised cellulose nanocrystals, such as the sodium form of the cellulose nanocrystals.

The structurally coloured films or particles of the invention have a cholesteric structure, which may also be referred to as a chiral nematic order. Thus, the films have a self-assembled structure that is not a non-helical chiral nematic.

The nanocrystals within the film or particle are in a helicoidal assembly. The helicoidal assembly has a defined pitch within the film or particle.

The cholesteric pitch, p, may be at most 2.0, at most 3.0, at most 4.0, at most 5.0, at most 6.0, at most 7.0, at most 8.0, at most 9.0, or at most 10 μm.

The cholesteric pitch, p, may be at least 0.05, at least 0.1, at least 0.2, at least 0.4, at least 0.5, at least 0.6, at least 0.7, at least 0.8, at least 0.9, at least 1.0 or at least 2.0 μm.

The cholesteric pitch, p, may be in a range selected from the upper and lower limits given above. For example, the cholesteric pitch, p, may be within the range 0.05 to 10 μm, such as 0.4 to 4.0 μm, such as 0.4 to 2.0 μm.

The cholesteric pitch, p, may be associated with a film or particle having structural colour in the visible range.

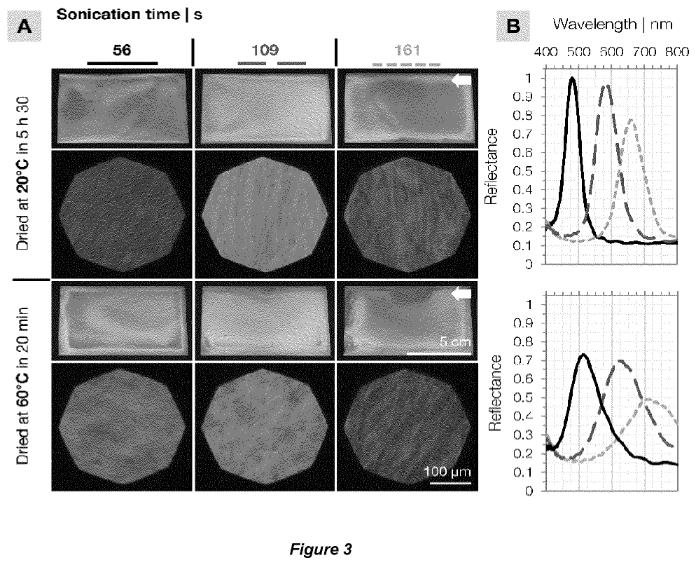

The cholesteric pitch may be controlled by selection of appropriate conditions during preparation of the nanocrystal suspension. For example, the cholesteric pitch can be increased by sonicating the nanocrystal suspension prior to film formation (FIG. 3).

Similarly, annealing the film may result in a small compression of the cholesteric pitch as a result of the removal of water molecules (FIG. 7). The cholesteric pitch may also be altered by adjusting the properties of the nanocrystal suspension prior to deposition.

The cholesteric pitch may be measured, for example in a dried particle, from SEM images of the particle, where the helicoidal assembly of the nanocrystals is visible in the form of Bouligand arches, the periodicity of which can be measured.

The films and particles of the invention have structural colour. Thus, the cholesteric ordering permits Bragg reflection of incoming electromagnetic radiation in the visible, infrared or ultraviolet regions of the spectrum. The reflected wavelengths follow Bragg's law: λ=n×p×cos θ, where n describes the average refractive index, p is the pitch of the helicoid and e is the angle of incident light with respect to the director m of the cholesteric structure.

The observed (reflected) colour may be ultraviolet colour, visible colour or infrared colour, and it is preferably visible colour. Visible colour refers to a colour with a wavelength in the range about 400 to about 800 nm. Infrared colour refers to a colour with a wavelength in the range about 700 nm to about 1 mm, most commonly about 700 nm to about 5 μm. Ultraviolet colour refers to a colour with a wavelength in the range about 100 nm to about 400 nm, commonly about 200 nm to about 400 nm, such as about 300 nm to about 400 nm.

The colour of the films or particles may be measured using standard techniques, such as using an optical microscope coupled with a spectrometer, used in bright field imaging configuration with or without polariser. The reflectance values are measured relative to the reflectance of a mirror, typically a silver mirror (maximal reflectance) used to obtain the normalized reflectance of the sample. The background noise is subtracted. The reflectance values are measured in the visible range (300 nm to 800 nm). Typically, the samples are mounted flat on the stage of the microscope such that the light rays can be considered to travel perpendicular to the sample's surface to measure reflection at normal incidence, with the light being collected within the cone (numerical aperture) of the objective (maximal reflectance). Typically, the reflectance values are measured in air.

### Films

In a further aspect, the present invention provides a structurally coloured film comprising or consisting of nanocrystals, preferably cellulose nanocrystals. The nanocrystals in the film are in the chiral nematic phase. Typically, the structurally coloured film composes neutralised cellulose nanocrystals, such as sodium form cellulose nanocrystals.

The structurally coloured films may be produced by the methods described above. Accordingly, the invention provides a structurally coloured film obtained or obtainable by the methods of the invention.

Preferably, the films have a thickness (such as a dry thickness) which is large enough to permit the director of one chiral nematic structure within the film to perform a complete revolution, and more preferably four complete revolutions, as this imparts excellent optical properties to the film. Accordingly, the structurally coloured film has a thickness of from 1.0 μm to 50 μm, preferably from 2.0 μm to 20 μm, more preferably from 6.0 to 12.0 μm, such as around 9.0 μm.

The thickness of the films or particles may be measured using standard techniques, such as measuring the thickness of a cross-section of the film using SEM.

The highly ordered chiral nematic structures in the films are highly reflective and reflect highly saturated colors with high intensity.

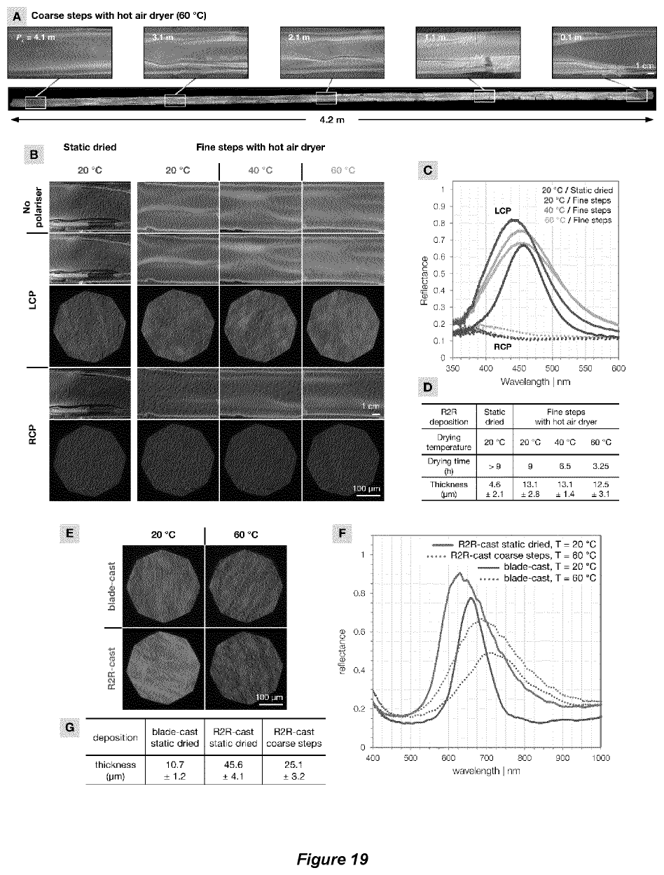

The structurally coloured films reflect 50% or less of the incident light at a given wavelength in the visible range (300 nm to 800 nm; FIG. 3; FIG. 19). Preferably, the films reflect 30% or more of the incident light, more preferably 40% or more, even more preferably 45% or more and most preferably 49% or more.

The reflectance of the films can be measured using standard techniques, such as an optical microscope coupled with a spectrometer. The reflectance values are measured relative to the reflectance of a mirror, typically a silver mirror (maximal reflectance) used to obtain the normalized reflectance of the sample. The background noise is subtracted. The reflectance values are measured in the visible range (300 nm to 800 nm). Typically, the samples are mounted flat on the stage of the microscope such that the light rays can be considered to travel perpendicular to the sample's surface to measure reflection at normal incidence, with the light being collected within the cone (numerical aperture) of the objective (maximal reflectance). Typically, the reflectance values are measured in air.

The films may reflect light of different wavelengths with different reflectance (bandgap).

At 500 nm, the films typically exhibit a reflectance of 70% or more, preferably 80% or more, more preferably 90% or more and most preferably 99% or more (FIG. 3).

At 600 nm, the films typically exhibit a reflectance of 65% or more, preferably 75% or more, more preferably 85% or more and most preferably 95% or more (FIG. 3).

At 700 nm, the films typically exhibit a reflectance of 60% or more, preferably 70% or more preferably 80% or more and most preferably 90% or more (FIG. 3).

In addition to high absolute reflectance values, the light reflected by the structurally coloured films is also highly saturated. Thus, the chiral nematic structure selectively reflects light of a given wavelength range. Thus, the reflectance spectra of the material has sharp peaks.

The full width at half maximum of the reflected light is typically 150 nm or less, 100 nm or less, preferably 75 nm or less, and more preferably 50 nm or less (FIG. 3).

In the range 400 nm to 550 nm, the films typically exhibit a full width at half maximum of 50 nm or less (FIG. 3).

In the range 450 nm to 800 nm, the films typically exhibit a full width at half maximum of 100 nm or less (FIG. 3).

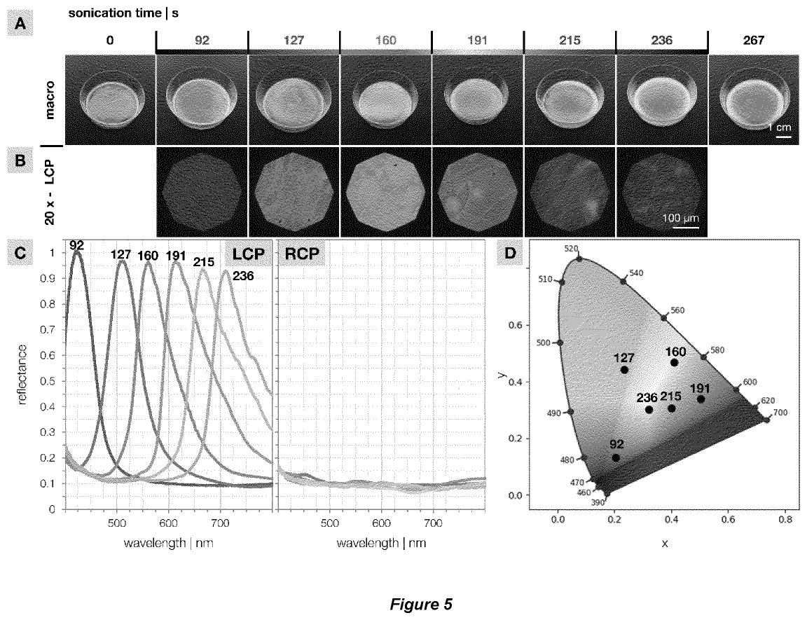

Example of structurally coloured films with high reflectance are shown in FIG. 5, where the CIE plot shows the extent of the colour gamut from such films.

The reflected structural colour is iridescent, and so it is angle-dependent. The level of iridescence can be controlled through the extent of disorder of the chiral nematic structure within the film.

The edges of the structurally coloured film that form chiral nematic structure are prone to a “coffee stain” effect, which leave edges with less homogenous and less optimal visual appearance than away from the edges. These parts of the film can be removed after completion of the drying, to further improve optical properties.

In some cases, the structurally coloured film has been treated such as by annealing to remove sulfuric acid groups and tightly bound water molecules.

Sulphate half-ester groups are commonly grafted during the extraction of cellulose nanocrystals, such as sulfuric acid hydrolysis. Sulphate half-ester groups are typically located on the C6 position of the repetitive glucose unit. The amount of sulphate half ester group being removed depends on the temperature and conditions used for carrying out the heat-treatment and the content of sulphate half-ester groups covering the nanocrystal surface.

Typically, the decrease of sulphate content is 15% or more, 30% or more, preferably 50% or more, more preferably 70% or more, and even more preferably 90% or more, and most preferably 98% or more.

In this way, the film maintains colour even when placed in a solvent such as water without disintegrating. A lower loss of sulphate content as a result of a shorter or lower temperature annealing is linked to lower/shorter stability in water and other aqueous based solutions.

### Particles

In another aspect, the present invention provides structurally coloured particles comprising or consisting of nanocrystals, preferably cellulose nanocrystals. The nanocrystals in the particles are in the chiral nematic phase. Typically, the structurally coloured particles comprise cellulose nanocrystals such as neutralised or sodium form cellulose nanocrystals.

The structurally coloured particles may be produced by the methods described above, such as dividing the structurally coloured films described above. Accordingly, the invention provides a structurally coloured particle obtained or obtainable by the methods of the invention.

The steps of processing the film into particles preserves the chiral nematic structures of the nanocrystals without significantly altering them. The particles produced by the methods above have exceptional optical quality such as high intensity and saturation.

Generally, the structurally coloured particles have a median average particle diameter of 5000 μm or less, 1000 μm or less, 500 μm or less, preferably 300 μm or less.

Generally, the structurally coloured particles have a median average particle diameter of 2 μm or more, 5 μm or more, preferably 15 μm or more, more preferably 25 μm or more.

Generally, the median average particle diameter of the structurally coloured particles may be selected from a range with the upper and lower limits selected from the values given above. For example, the median average particle diameter of the structurally coloured particles may be from 15 μm to 300 μm, preferably 25 μm to 300 μm.

In one embodiment, the structurally coloured particles have a median average particle diameter of 14 μm to 127 μm, preferably 28 μm to 113 μm, more preferably 35 μm to 106 μm.

In another embodiment, the structurally coloured particles have a median average particle diameter of 84 μm to 254 μm, preferably 99 μm to 226 μm, more preferably 106 μm to 212 μm.

The median average particle diameter of the structurally coloured particles may be selected from a range with the upper and lower limits selected from the values given above. For example, the median average particle diameter of the structurally coloured particles may be from 170 μm to 495 μm, preferably 198 μm to 453 μm, and more preferably 212 μm to 424 μm.

The size of the structurally coloured particles may be determined using standard techniques. For example, the median average particle diameter of the structurally coloured particles may be measured by SEM or optical microscopy. Preferably, the surface area of each particle is measured and then the diameters of a spherical particle having the same surface area is calculated to retrieve the diameter. This diameter is recorded as the diameter of the particle and the median average of all particles measured is calculated from the individual particle diameters.

The structurally coloured particles typically have an average surface area of 78,500,000 μm² or less. Preferably, the structurally coloured particles have an average surface area of 3,140,000 μm² or less, more preferably 785,000 μm² or less, even more preferably 282,000 μm² or less, and most preferably 100,000 μm² or less.

The structurally coloured particles typically have an average surface area of 80 μm² or more. Preferably, the structurally coloured particles have an average surface area of 700 μm² or more, more preferably 1,960 μm² or more, even more preferably 4,000 μm² or more, and most preferably 6,000 μm² or more.

The average surface area of the structurally coloured particles may be selected from a range with the upper and lower limits selected from the values given above. For example, the average surface area of the coloured particles may be from 4,000 μm² to 100,000 μm², preferably from 6,000 μm² to 40,000 μm².

The average surface area of the structurally coloured particles may be measured by SEM or optical microscopy. Preferably, the surface area of each particle is measured and the mean average of all the particles is calculated to give the average surface area.

In some cases, the structurally coloured particle has a rock-like shape (FIG. 4). In some cases, the structurally coloured particle may have facets where the chiral nematic phase is revealed.

Typically, the particles have at least 4 distinguishable facets, originating from the nucleation and growth of the self-assembled cholesteric domains. The particles may comprise one or more cholesteric domains, preferably one cholesteric domain.

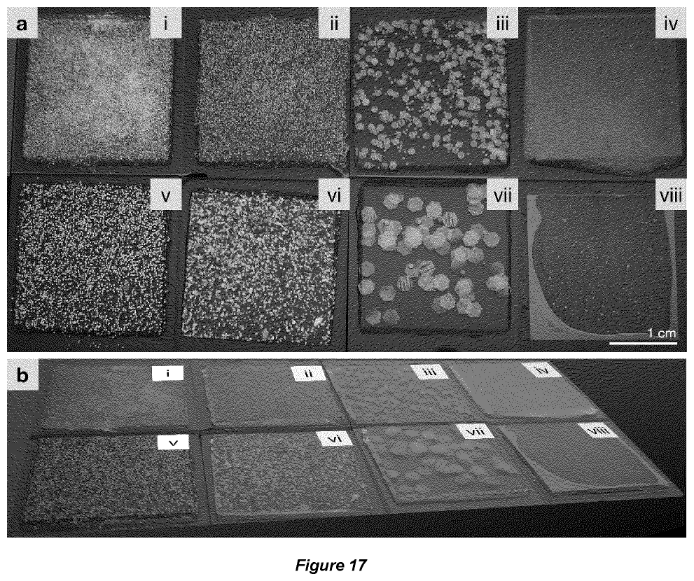

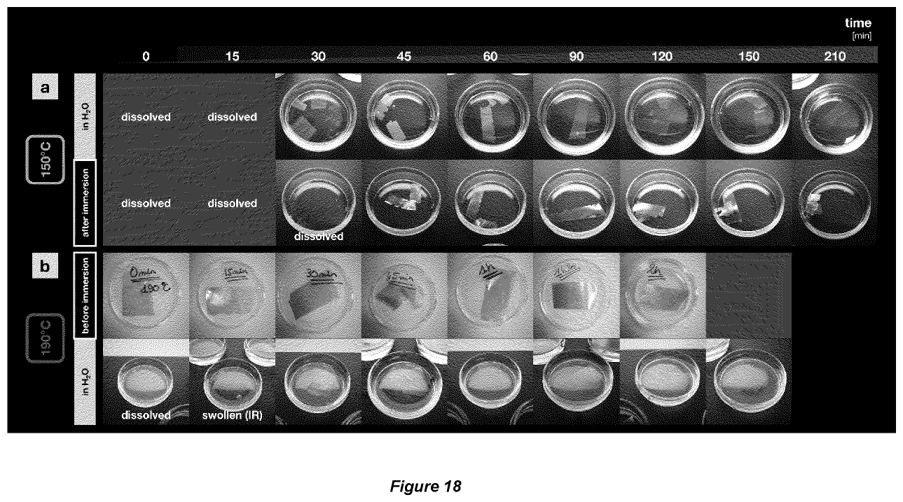

The highly ordered chiral nematic structures in the particles result in high reflectivity. This is in sharp contrast with the particles described in WO 2018/033584 and demonstrated by a side-by-side comparison against this work in FIG. 17 viii.

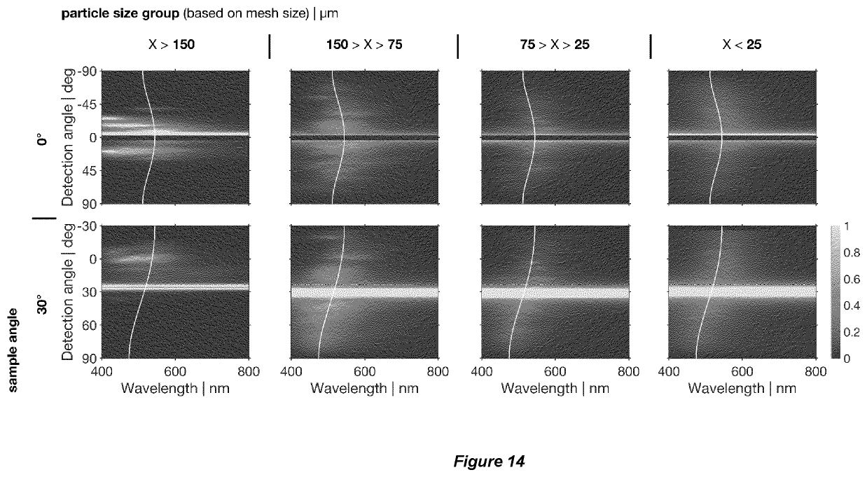

The structurally coloured particles reflect 25% or more of the incident light at a given wavelength in the visible range (300 nm to 700 nm; FIG. 4, FIG. 14). Preferably, the particles reflect 30% or more of the incident light, more preferably 35% or more, and even more preferably 40% or more.

The reflectance of the particles can be measured using standard techniques, such as using an optical microscope coupled with a spectrometer, used in bright field imaging configuration with or without polariser. The reflectance values are measured relative to the reflectance of a mirror, typically a silver mirror (maximal reflectance) used to obtain the normalized reflectance of the sample. The background noise is subtracted. The reflectance values are measured in the visible range (300 nm to 800 nm). Typically, the samples are mounted flat on the stage of the microscope such that the light rays can be considered to travel perpendicular to the sample's surface to measure reflection at normal incidence, with the light being collected within the cone (numerical aperture) of the objective (maximal reflectance). Typically, the reflectance values are measured in air.

The particles may reflect light of different wavelengths with different reflectance.

At 500 nm, the particles typically exhibit a reflectance 30% or more of the incident light, more preferably 35% or more, and even more preferably 40% or more (FIG. 4).

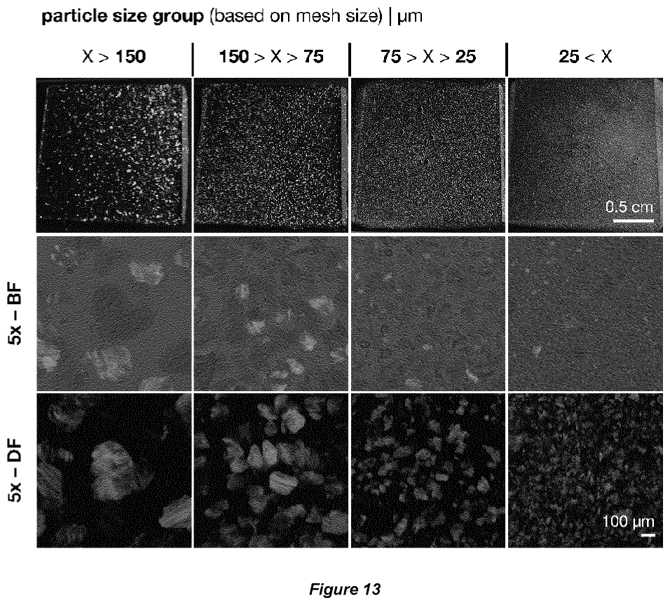

After dividing, the optical properties of the structurally coloured film are generally retained and observed in the particles (FIG. 4). However, as the dimensions of the structurally coloured film decrease during the dividing step to the point where the structurally coloured film breaks apart into micron-size objects, light is scattered more at the interface of the particle and this results in a whiter appearance of the structurally coloured particles in air than of the structurally coloured film. However, the scattering superimposes on the structural colour from the particles so that the optical response from the chiral nematic structure can still be measured, even for the smallest particles. Indeed, as shown in FIG. 13 once the structurally coloured particles are embedded in an refractive index matching medium, such as a polymer resin, the colour is retrieved as the scattering at the interface of the particle is suppressed.

The full width at half maximum of the reflected light is typically 150 nm or less, and preferably 125 nm or less (FIG. 4).

In the range 400 nm to 650 nm, the films typically exhibit a full width at half maximum of 150 nm or less, and preferably 125 nm or less (FIG. 4).

Example of structurally coloured particles with high reflectance are shown in FIG. 4.

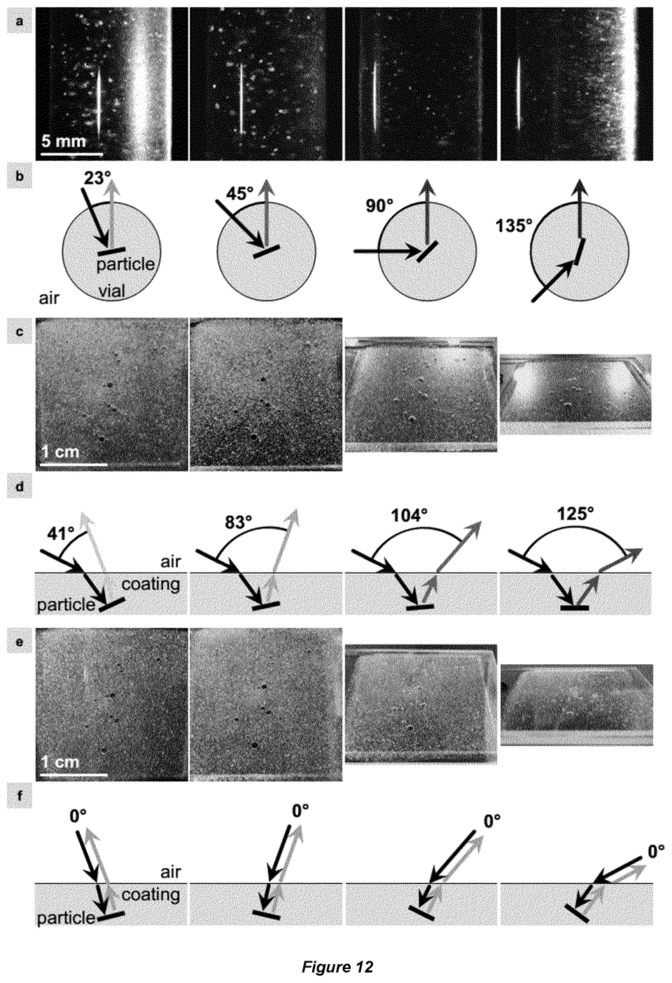

The reflected structural colour is iridescent, and so it is angle-dependent (FIG. 12). The level of iridescence can be controlled through the extend of disorder of the chiral nematic structures within the particle.

Importantly, the structurally coloured particles maintain colouration when placed in solution or a matrix such as a polymer matrix (FIG. 12).

The colour of the particles in solution or matrix can be identical to the one in air. This is the case for instance upon immersion in dry solvent such as ethanol (FIG. 4).

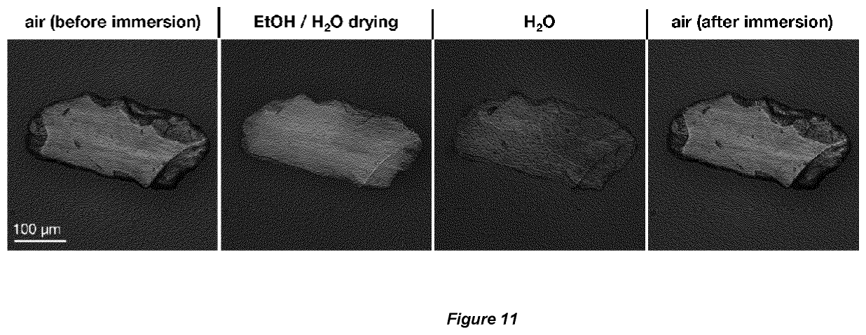

The colour of the structurally coloured particle may vary depending on the medium it is in (FIG. 11).

It is proposed that this variation in colour change is due to different amounts of swelling in the different mediums, which may be large in the case of water, and may be proportional to the ionic strength of the medium.

For example, starting from a green particle in air, the swelling in a mixture of water and ethanol result in some particles appearing red and others reflecting infrared.

In the case of liquid solvent such as water, the swelling is reversible, and the colour of the structurally coloured particle can be returned to its original colour (i.e. it's colour in air alone) by drying.

The swelling of the particles may result in an instant red shift of the reflected light of at least 2 nm, at least 5 nm, at least 10 nm, or at least 50 nm.

The swelling of the particles may result in an instant red shift of the reflected light of at most 100 nm, at most 150 nm, at most 175 nm, or at most 200 nm.

The swelling of the particles may result in an instant red shift of the reflected light selected from the upper and lower limits given above. For example, the wavelength shift of the particles may be within the range 2 to 150 nm, such as 10 nm to 100 nm.

The swelling is limited and does not lead to the redispersion of the nanocrystals over a prolonged period of time. Typically, the particles are stable on immersion in water for 30 minutes or more. Preferably, the particles are stable on immersion in water for 1 hour or more, more preferably 2 hours or more, even more preferably 4 hours or more and most preferably 8 hours or more.

The stability of the particles can also be assessed by considering the weight retention of the particles. Typically, the particles retain their integrity and lose less than 15% of their weight, preferably less than 10% and even more preferably less than 5% of their weight after immersion in water for, for example 1 hour or more.

The stability of the particles can also be assessed by considering the reflectance of the particles on or immersion in water. Typically, the particles have a reflectance comparable to their reflectance in air, with the difference that the reflection peak may be redshifted as discussed above.

### Uses and Applications

The films or particles of the present invention may be used in a variety of different ways to replace known colourants such as dyes, pigments and glitters (FIG. 17).

The film prior to dividing may be cut to specific size in order to obtain elements with given shape, such as stripes which can be applied as such or laminated and use for instance as moisture sensor for food safety application, as textile fibres and for security labelling. Accordingly, the present invention provides a security label such as for anticounterfeiting application or moisture sensor comprising a structurally coloured film or particle of the invention.

The particles are particularly suitable for use as pigments owing to their ability to provide structural colour, including visible, infrared and ultraviolet colour. The following examples are not exhaustive and only highlight some possible ways to use the particles.

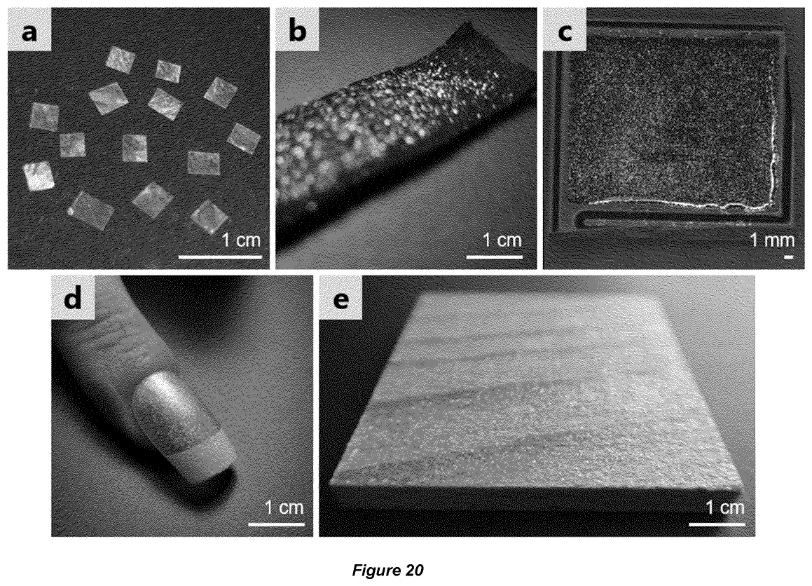

The particles may be used in cosmetics, such as cosmetic powder for application to skin such as but are not limited to blusher, body powder, bronzing powder, eye shadow, face powder, lip powder, powder makeup and other cosmetics where the particles are formulated such as in a fluid, an oil or wax based system for instance, without being limited to: bronzing product, eye pencil, eyeliner, face makeup, facial foundation, hair gel, hair paste, hair spray, lip gloss, lipstick, mascara, nail varnish (see FIG. 20D), body wash, shampoo, shower gel, skin cream, sun cream and tanning products. Accordingly, the present invention provides a cosmetic comprising a structurally coloured particle of the invention.

The particles may be used in inks, in paints, in coatings, in packaging, in acoustic devices, in heat and wavelength management applications such as far radiative cooling, in electrophoretic display and devices, in seasonal products, for decorative use, for garments. As for application in cosmetic products, these applications may require the particles to be added to a host formulation.

The particles provide additional functionality and alter the non-optical properties of the host formulation, for instance the rheological, texture or mechanical properties, heat, acoustic and energy transfer ability, electrochemical, electromagnetic or electrophoretic properties of the host formulation. For example, the particles may provide a colour effect to the host formulation in cosmetic application and acts as a filler, a thickening agent or an exfoliating microparticles in consumer and healthcare products, including cleaning compositions and cosmetic compositions.

As a food and beverage additive, the particles may be a colouring agent and the host formulation may comprise further ingestible ingredients for use in the preparation of the food or beverage. Additionally, the particle may be used in drinks (FIG. 16E) or in confectionary such as chocolate (FIG. 20C).

For decorative, packaging and security applications, the particles and the host formulation can be applied over paper, polymers, cardboard, molded fibres, stamps and labels, wood veneer, furniture, and lignin-containing materials. In addition, the particles and the host formulation can be applied over wood (FIG. 20E), metals ceramic, glass, garments, fabric (FIG. 20B). The substrate bearing the particles and host formulation can be applied to cover part or the whole of an article as, for example, a stamp, label, or foil. For garments, the particles can be used as sequins. Additionally, the particles may be used as confetti (FIG. 20A). The particles may be sprayed, sewn, glued to a substrate for the desired application.

The host formulation is preferably transparent but may contain other colouring agents such as dyes or pigments to produce more complex colour effects with the addition of the particles of this invention.

The host formulation may be viscous enough to hold the particles in place or may have a viscosity which is low enough for the particles to move freely. In the case of a low viscosity liquid (FIG. 12-A), the glittery appearance results from the random change of orientation of the particles in the medium and does not necessitate to observe the samples at different viewing angle to obtain a “sparkle” effect. In the case of a viscous host formulation (FIG. 12-C), the particles may give a glittery appearance to the host suspension when observed as different angle. Moreover, the apparent iridescence depends on the illumination conditions (FIG. 12-E).

The size and size dispersity of the particles as well as the quantity of particles used and their orientation in the host medium determine the overall visual appearance resulting from the incorporation of the particles in the host formulation.

However, particles below a certain size embedded in a viscous host formulation give an overall less angular dependent optical response to the transparent coating they are in than particles above a certain size as shown in FIG. 13. For particles under a certain size, the macroscopic visual response of the host formulation containing the particles is averaging out over multiple randomly oriented particles and result in a more homogeneous and continuous visual appearance. FIG. 14 shows that the scattering response of some small, dispersed particles embedded in a transparent polymer resin is similar to that of a flat and continuous cellulose nanocrystal film.

The particles may be dispersed in a solvent or other formulation depending on their intended use. The solvent may be 2-propanol, 1,2-dichloroethane, 1,4-dioxane, 18-crown-6, 2-propanol, 2-ethoxyethanol, acetic acid, acetone, acetonitrile, ammonia, benzene, n-butanol, n-butyl acetate, chloroform, cyclohexane, dichloromethane, diethyl ether, diglyme, dimethyl formamide, Dimethyl sulfoxide, DME, ethane, ethanol, ethyl acetate, ethylene, ethylene glycol, formic acid, glycerine, heptane, hexane, hexamethylbenzene, HMDSO, HMPA, Hydrogen, Imidazole, isobutanol, isopropyl alcohol, methane, methanol, n-hexane, nitromethane n-pentane, propane, propylene, propylene carvonate, pyridine, pyrrole, pyrrolidine, silicone grease, tert-butyl alcohol, tetrahydrofuran, toluene, triethylamine, water, white spirit and xylene or a mixture thereof.

Preferably the solvent is a water-based solution or formulation.

The formulation can also be an emulsion, such as a water-in-oil emulsion, an oil-in-water emulsion, a double emulsion, such as a water-in-oil-in-water emulsion or an oil-in-water-in-oil emulsion, a gel, a latex, a resin or a visco-elastic polymer matrix or another type of advanced formulation involving several ingredients such as emollients, oils, polymers, surfactants and waxes, as suited for the intended application and use.

Suitable emollients include ammonium lactate, petrolatum, salicylic acid, urea.

Suitable polymers include acrylates/steareth-20methacrylatecopolymer, aromatic polymer (such as polycarbonate, polyester, polystyrene), Carbopol®, dimethylhydantoin-formaldehyde, halogenated polymer, hydrogenatedpolydecene, keratin, para-aramid, poloxamer, polyacrylamide, polyacrylonitrile, polyaminoacid, polyamide (such as Nylon 6, Nylon 6,6, Nylon 12), polyether, polyolefin (such as but are not limited to polyethylene, polyisoprene, polypropylene, polybutadiene, polyethylene glycol), polypeptide, polymethacrylate, polymethylmethacrylate cross-polymer, polymethylsilsesquioxanes, polyquaternium, silicones, silk fibroin, silk sericin, ulvan, vinyl acetate, vinyl acetate/crotonic acid copolymer, methyl vinyl ether and maleic semester copolymer, vinylpyrrolidone. The polymer can be a cellulose- or a lignin-derivative, such as cellulose acetate, cellulose nitrate, cellophane, nitrocellulose and celluloid. The polymer can be a starch-derivative. The polymer can be a chitin-, a chitosan- or a sericin derivative. The polymer can be an alignate-, a carrageenan —, a collagen-, gelatin-, hyaluronic acid- or pectin-derivative. Preferentially the polymer is synthetised from natural feedstock and/or biobased and/or renewable monomers, and the resulting polymer is preferably biodegradable such as aliphatic polyesters, for instance poly(lactic acid) poly (ε-caprolactone), and poly(3-hydroxybutyrate-co-3 hydroxy valerate). Suitable polymers also include polymer listed as possible additive of the nanocrystal suspension described above.

Suitable oils include algal oil, annatto oil, argan oil, almond oil, apricot kernel oil, avocado oil, babassu oil, Brazil nut butter, butter, cashew butter, castor oil, camellia oil, cheery kernel oil, cocoa butter, coconut oil, corn oil, cottonseed oil, fish oil, grape seed oil, gardenia oil, ghee, hazelnut oil, jatropha oil, jojoba oil, kokum oil, linseed oil, macadamia oil, maize oil, mango seed oil, mango butter, mineral oil, mink oil, olive oil, palm oil, palm kernel oil, peach kernel oil, peanut butter, peanut oil, plum kernel oil, pomegranate oil, rapeseed seed oil, rice bran oil, rosehip oil, sal oil, sesame oil, shea butter, soybean oil, squalene, sunflower oil, teas seed oil, walnut oil. Oil derivatives obtained from the aforementioned oils such as esterified oils, fatty acids, fatty alcohol, hydrogenated oils and triglycerides can be used as suitable ingredient for the said formulation. Essential oils are also suitable oils.

Suitable resin includes tosylamide formaldehyde resin and toluene-sulphonamide-formaldehyde resin.

Suitable wax include beeswax, candelilla wax, carnauba wax, Japan wax, lanolin, palm wax, paraffin.

Suitable gel includes any chemical and/or physical gel obtained from the use of thickeners such as cellulose-derivative thickener as well as acacia gum, agar, aloe gel, gelatin, guar gum, gum arabic, gum tragacanth, pectin, sodium alginate, starches, and xanthan gum. In addition, the gel may be a mixture of cellulose fibers.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### Experimental and Results

### Materials

Aqueous CNC suspension purchased from the University of Maine Process Development Center (batch number 2015-FPL-077, (CNC)=11.8 wt. %, neutralized form, 1.2 wt. % sulphur content).

PET reel for roll-to-roll coating was obtained from Mitsubishi Polyester Film Hostaphan RN 500 (thickness=500 μm, width=140 mm).

PET for laboratory scale and slot-die coating experiments was obtained from HIFI Film PMX727 for laboratory scale experiments.

### Instrumentation

Polarised optical microscopy was performed using a Zeiss Axio.Scope optical microscope (halogen lamp (HAL 100 Zeiss, nominal range: 350-1100 nm) equipped with the CNC films imaged using a 20× objective (Zeiss EC Epiplan APOCHROMAT, NA=0.3) and the CNC photonic particles with a 10× objective (Zeiss EC Epiplan APOCHROMAT, NA=0.6).

The light reflected by the CNC films attached to the substrate passes through a quarter wave plate and a switchable polarising filter, which, if used, can either only let left- or right-handed circularly polarized light (respectively LCP and RCP) pass through. The light was directed using a beamsplitter to a CCD camera (Thorlabs—DCC3240C) and sent to a spectrometer (Avantes AvaSpec HS2048) through an optical fibre.

A 600 μm-cored optical fibre (Thorlabs FC-UV600-2-SR) was used for measuring the CNC coatings with the 20× objective whereas a 200 μm-cored optical fibre (Thorlabs FC-UV200-2-SR) was used for the CNC photonic microparticles with the 10× objective. As a result, spectra were acquired over a ˜100 and ˜66 μm-wide spot respectively.

Unless stated otherwise, all the spectra were normalized to the reflection of a silver mirror (Thorlabs PF10-03-P01) in one polarisation channel (left-circularly polarised, LCP), such that a perfectly aligned cholesteric sample would reflect 100% in the LCP channel.

Photographs of the CNC films were acquired from CNC films attached to their PET substrate and were taken using a 20 MP digital camera (Huawei P10) at a fixed working distance and lighting on top of a black background. A mask was placed around the laboratory scale PET films to lay it flat without covering the edges of the CNC film. Other images were taken using a 40 MP digital camera (Huawei P30 Pro).

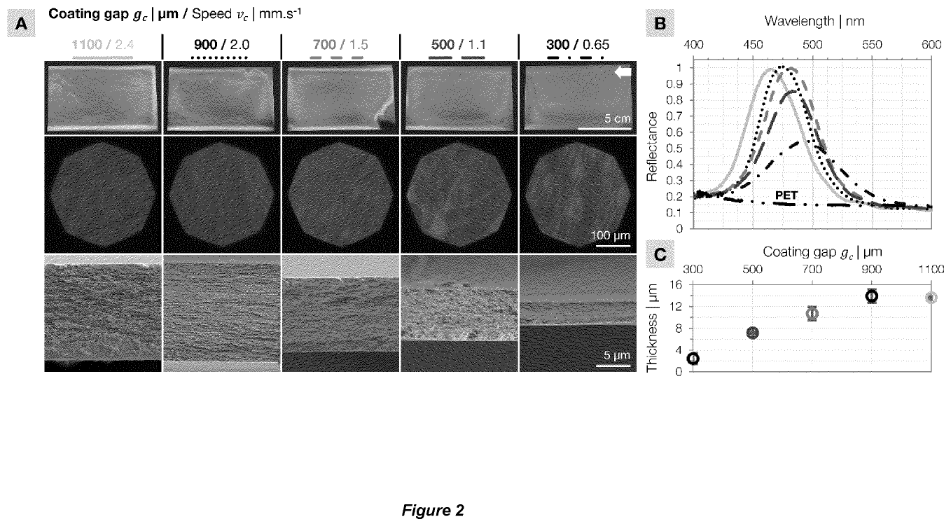

The thickness of the deposited CNC films was measured using a SEM (Tescan MIRA3 FEG-SEM), operated in high vacuum mode at 4 kV accelerating voltage and at a working distance of 3-4 mm. Samples were mounted on aluminium stubs with conductive carbon tape, and sputter-coated (Emitech K550) using a palladium target. The results are shown for example in FIG. 2-A.

Angular-resolved optical spectroscopy measurements were carried out using a bespoke laboratory goniometer: a lamp (Thorlabs SLS201L/M) was used as the light source, and a spectrometer (AvaSpec-HS2048XL, Avantes) was used to analyse the scattered optical signal. The sample was mounted on a rotating stage in the centre of the goniometer and illuminated (via an optic fibre Ø=1000 μm) with a collimated incident beam on the sample surface (light spot size Ø ˜ 6 mm). A detector was mounted on an arm attached to a motorised rotation stage and coupled the scattered light into an optic fibre (Ø=600 μm) connected to the spectrometer. The recorded light intensity was normalised with respect to a white Lambertian diffuser (Labsphere USRS-99-010), while the exposure time was adjusted using an automated high dynamic range method44. Measurements were recorded at a fixed incident light angle (taken as either θin=0° or 30°, defined from the normal of the sample interface), and by scanning the scattered spectral intensity collected with the rotating detector at various outgoing angles θout.

Sweep rheological measurements were performed using a rotational rheometer (TA Instruments DHR-2) equipped with a 40 mm parallel Peltier steel plate geometry, using a gap of approximately 900 μm and applying CNC suspension (1 mL) on a temperature-regulated stage (20° C.).

### Cellulose Nanocrystal Suspension

The aqueous CNC suspension (see Materials) was diluted with ultrapure water to 6 wt % by batch of 25 mL in an ice bath in Corning Falcon® tubes (50 mL) and sonicated using an ultrasonic disintegrator (Fisherbrand 505 Sonic Dismembrator, 500 W, amplitude=40%, tip diameter=12.7 mm).

Suspensions for laboratory-scale blade-cast CNC films were prepared by batches of 25 mL and sonicated for 56, 109, and 161 s to produce respectively blue, green and red films upon casting. Suspensions for large-scale R2R deposition were prepared by batches of 45 mL, in which case the sonication time was respectively scaled-up to 101, 196 and 290 s. This allows for the energy delivered per volume of CNC suspension by the tip sonicator to be kept constant and corresponds to treatments of 2.24, 4.36 and 6.44 s/mL (or 7.5, 14.5 and 21.5 KJ/g).

After equilibrating the suspension for 1-3 days at ambient temperature, the denser anisotropic phase was separated and collected for further use.

The colour of the dried CNC film could be red-shifted by increasing the duration of the tip sonication process (see FIG. 3 and FIG. 5), allowing for red, green and blue films to be produced from tip sonication at 6.44, 4.36 and 2.24 s/mL (or 21.5, 14.5 and 7.5 KJ/g).

### Substrate Preparation and Treatment

Polyethylene terephthalate (PET) was used as a substrate for CNC film deposition, with the surface selectively activated to control wetting.

PET sheets (thickness=125 μm, length=120 mm, width=80 mm, with a coatable width of 60 mm) were secured to the coating stage for laboratory scale experiments. A plasma etcher was used to activate the surface (EMITECH K1050X plasma etcher, 50 W, 5 min).

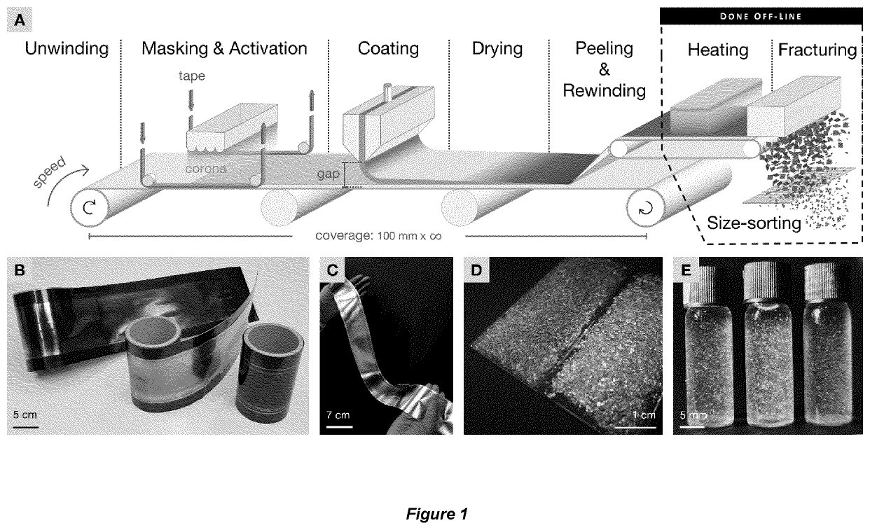

In contrast, roll-to-roll deposition required the use of a PET reel (thickness=500 μm, width=140 mm). Corona discharge (Corona Supplies, power=0.3 kW) was used to activate the continuously moving substrate (speed=0.1 mm·s⁻¹=1.7 mm·s⁻¹). The PET reel was masked with tape (see FIG. 1A) manually in these examples but this could be continuously deposited as proposed in FIG. 1A.

### Deposition of Photonic Cellulose Nanocrystal Coatings

Laboratory-scale CNC coatings were prepared using a bespoke film coater with a maximum coating length of ca. 30 cm. This comprised of a motor (Reliance Cool Motion Stage) which could move a flat stage along a track, above which a coating applicator (BEVS 1806/A50) was mounted at a fixed position.

To prepare a CNC coating the PET substrate was attached to the stage on three sides, with the trailing edge free to allow excess CNC suspension to be removed by the coater. The blade was set to the desired height above the substrate and coating applicator positioned near the front of the rectangular PET sheet. CNC suspension (3.5 mL) was deposited in front of the blade and the stage moved (speed from 0.65 to 2.4 mm/s and coating gap from 300 to 1100 μm for the sample shown in the case of the examples in FIG. 2) such that an area of 6×10 cm was uniformly coated.

Roll-to-roll coating was used to achieve continuous deposition of the CNC suspension and demonstrate the scalability of the process. Roll-to-roll printing was achieved using a modified roll-to-roll coating system (Coatema Coating Machinery, Smartcoater 28) equipped with a custom-made slot-die (coating width=10 cm, internal reservoir 22 mL). The slot die was made of two screw-joined aluminium plates separated by a 125 μm-thick spacer shim configured for a 100 mm slot clearance positioned perpendicular to the web.

A syringe pump (New Era) was used to continuously dispense the CNC suspension to the slot-die, with the dispensing rate (ca. 6000 μL/min) adjusted depending on the desired film thickness and coverage width.

The distance between the slot lips and the substrate was controlled with a thickness feeler gauge.

Web-holders were placed so that the average distance between each holder was reduced to 30 cm. The substrate was levelled before coating using a bullseye spirit level (Thorlabs LVL01) at several positions along the web path and at the middle of the width. The web was translated through the roll-to-roll system at the lowest accessible speed (speed=0.1 mm·s⁻¹=1.7 mm·s⁻¹). Shear rates were calculated from the translational speed of the web and the coating-gap thickness.

Furthermore, the removal of the CNC film from the web is neat, allowing to reuse the web several times in a close loop fashion.

For ‘static drying’, the web was translated through the R2R system at the lowest accessible speed (vc=0.1 m·min-1≈1.67 mm·s-1), with a maximum casting length of ca. 3 m, corresponding to the limits of the web pathway. The web translation was then stopped, and the deposited suspension was allowed to dry under ambient conditions. Alternatively, to investigate faster drying, a blown-air heating chamber (length≈40 cm, T=20-60° C.) was placed across the R2R pathway after the coating step. This allowed for a continuous stepwise deposition and drying process, whereby the translation of the web was divided into multiple steps interrupted by stationary rest periods. Two step sizes were demonstrated (denoted ‘coarse’ and ‘fine’): for the ‘coarse’ process, the web was translated at vc=1.67 mm·s-1 in steps of 20 cm every 15 min while for the ‘fine’ process, the web was translated at the same speed, but in steps of 5 cm every 3.75 min. In both cases, this corresponds to an effective translation speed of v_{eff}≈0.2 mm·s⁻¹ (FIG. 19).

Roll-to-roll printed films are shown in FIGS. 1B and 1C, and FIG. 19. These shows the colouration of films produced using the continuous roll-to-roll method is maintained and in the case of FIG. 1C demonstrate the scalability of the process of the invention.

The effect of coating gap and speed on colour was studied. The experiments were carried out as above with varying coating gaps and speeds. The results are shown in FIG. 2. The results show that reasonable colouration (peak height corresponding to 55% of maximal LCP reflection) can be achieved for coating gaps as low as g_{c}=300 μm and that increasing the coating gap and speed improves the optical properties. FIG. 2 also shows the relationship between the coating gap and the thickness of the resultant dry film.

### Drying

The CNC suspension was allowed to dry at ambient conditions without motion until completion of the film formation for the dish-cast films, the laboratory scale coatings and the large scale R2R coatings (for a few hours and typically less than a day which duration depends on the amount of material deposited, length and thickness of covered areas). Additionally, laboratory blade-coated films were also dried more rapidly using a hot plate set at 60° C. Despite using the lowest speed accessible on the R2R machine (v_{c}=0.1 m·min⁻¹), the time required for the drying of large-scale CNC suspension at ambient conditions exceeded the available length of our pilot-scale R2R machine. As such drying was either (i) performed without motion over several hours until film formation and is denoted as ‘static dried’ in the discussion, or (ii). the deposited CNC suspension was slowly translated through an in-line hot air dryer (T=20-60° C.) using the ‘step-wise continuous’ translation process described above, allowing for the drying process to be accelerated such that the film was dry before reaching the end of the web pathway.

The effect of drying rate on colouration was studied. Heated laboratory blade coated films were dried over a hot plate set either at 40° C. or 60° C. (FIG. 3-A, bottom row). The resulting films maintain colouration demonstrating that heating can be used to speed up drying which is industrially advantageous.

Additionally, a CNC film was dried over a perforate aluminium grid placed over a hot plate at 60° C. The results are shown in FIG. 9. The difference in temperature between the areas over the aluminium board and those over the air holes results in different colour shift.

### Fracturing, Annealing and Size Sorting

The transformation of the roll-to-roll film into CNC photonic particles was performed off-line due to the constraints of the system used. This transformation, including the annealing step, could be performed in-line provided a heat-resistant conveyor belt such as shown in FIG. 1A.

The R2R CNC film was detached from the substrate placing a thin plastic blade attached to the upper collection web at an angle between the substrate and the CNC film (as depicted on FIG. 1 and FIG. 16A) manually peeled over few centimetres beforehand and by moving the web at a constant speed.

The CNC films were annealed (heat-treated) in an oven (Nabertherm, P330) for 30 min at 180ºC.

The CNC film was chopped using a coffee grinder. The CNC glitter particles were size sorted sequentially using sieves with decreasing mesh size of 150, 75 and 25 μm. The results are shown in FIG. 4. The median size of the particles for each size category was retrieved from SEM images by highlighting the contours of individual particles and fitted with the Ferret area function in imageJ.

The results show good colouration for all particle sizes in air and in a number of solvents. The larger particles exhibit the best optical properties.

The effect of annealing temperature was studied. The experiments were carried out as above with varying annealing temperatures. The results are shown in FIG. 7. The results show that annealing the film results in retention of optical properties up to 220° C. Thus, annealing can maintain optical properties and provide stable films for fracturing. Higher temperatures result in carbonisation of the film and complete loss of colouration.

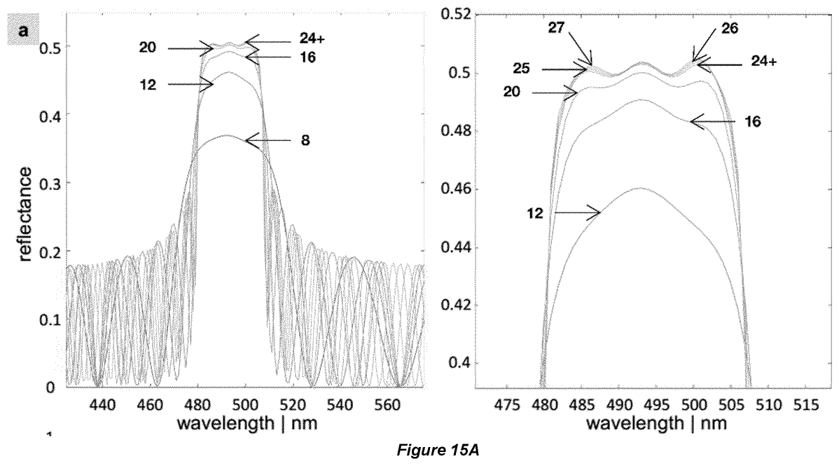

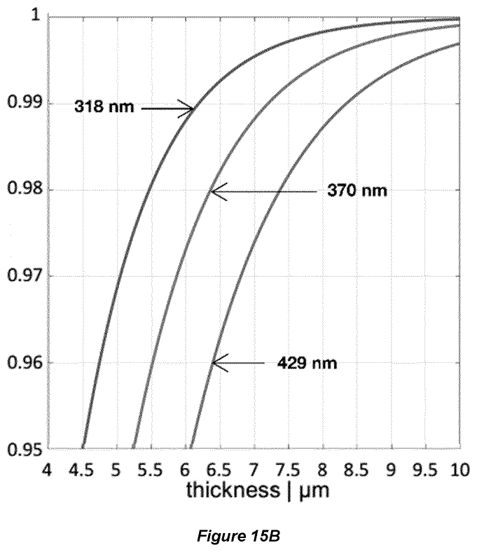

The decrease of the peak reflectivity in FIG. 3 from the red films can be ascribed to the given film thickness for the number of repetitive chiral nematic unit reflecting light. FIG. 15-A clearly shows that larger number of chiral nematic repetitive unit leads to more light being reflected from the chiral nematic structure. As such, for films reflecting larger wavelengths, such as red or infrared wavelengths, thicker films are needed to reach maximal reflectance from the cholesteric structure. It results that the film thickness may be tuned according to the wavelengths reflected from the film.

As analytical calculations show (FIG. 15-B), a film with a chiral nematic pitch centred on p=318 nm (reflecting blue wavelengths) will reflect approximately 50% of the maximum amount of light that the chiral nematic structure permits if the film is 1.8 μm-thick, but can reflect 95% of this maximum if the film is 4.5 μm-thick and can reflect more than 99% of such if its thickness is greater than 6.2 μm. A film with a chiral nematic pitch centred on 429 nm (reflecting red wavelengths) will reflect approximately 50% of the maximum amount of light that the chiral nematic structure permits if the film is 2.3 μm-thick, but can reflect 95% of this maximum if the film is 6.1 μm-thick and can reflect more than 99% of such if its thickness is greater than 8.4 μm.

### Additional Applications of Structurally Coloured Films and Particles

The films and particles prepared as described above were tested in various applications. These are shown in FIG. 20.
A) The structurally coloured film was divided into a square shaped structurally coloured particle. The particles were separated and presented over paper.
B) The structurally coloured film was divided into particles and applied to a piece of fabric using an adhesive.
C) Structurally colour particles were embedded in an edible host matrix and applied over a piece of chocolate.
D) Structurally colour particles were dispersed in a cosmetic nail varnish composition, and painted onto a finger nail.
E) Structurally colour particles were dispersed in a host polymer matrix, and painted onto a piece of wood.

### REFERENCES

All documents mentioned in this specification are incorporated herein by reference in their entirety.
Chowdhury, R. A., et al. Continuous roll-to-roll fabrication of transparent cellulose nanocrystal (CNC) coatings with controlled anisotropy. Cellulose 25, 1769-1781 (2018).
Frka-Petesic, B. & Vignolini, S. So much more than paper. Nat. Photonics 13, 365-367 (2019).
Gicquel, E. et al. Impact of sonication on the rheological and colloidal properties of highly concentrated cellulose nanocrystal suspensions. Cellulose, 7, 7619-7634 (2019).
Giese, M. et al. Responsive mesoporous photonic cellulose films by supramolecular cotemplating. Angew. Chemie—Int. Ed. 53, 8880-8884 (2014).
Gray, D. G. Recent advances in chiral nematic structure and iridescent color of cellulose nanocrystal films. Nanomaterials 6, 213 (2016).
Koppolu, R. et al. Continuous roll-to-roll coating of cellulose nanocrystals onto paperboard. Cellulose 25, 6055-6069 (2018).
Lagerwall, J. P. F. et al. Cellulose nanocrystal-based materials: from liquid crystal self-assembly and glass formation to multifunctional thin films. NPG Asia Mater. 6, e80 (2014).
Nan, F. et al. Enhanced toughness and thermal stability of cellulose nanocrystal iridescent films by alkali treatment. ACS Sustain. Chem. Eng. 5, 8951-8958 (2017).
Park, J. H. et al. Macroscopic control of helix orientation in films dried from cholesteric liquid-crystalline cellulose nanocrystal suspensions. ChemPhysChem 15, 1477-1484 (2014).
Parker, R. M. et al. The self-assembly of cellulose nanocrystals: hierarchical design of visual appearance. Adv. Mater. 30, 1704477 (2018).
Parker, R. M. et al. Hierarchical self-assembly of cellulose nanocrystals in a confined geometry. ACS Nano 10, 8443-8449 (2016).
Revol, J.-F. et al. Solid self-assembled films of cellulose with chiral nematic order and optically variable properties. J. Pulp Pap. Sci. 24, 146-149 (1998).
Shafiei-Sabet, S. et al. Rheology of nanocrystalline cellulose aqueous suspensions. Langmuir 28, 17124-17133 (2012).
WO 2017/091893—Andrews, M. & Morse, T. Cellulose-based organic pigments. (2017).
WO 2014/118466—BARDET, R., BRAS, J., BELGACEM, N., Agut, P. & DUMAS, J. Procédé de marquage d′un papier. (2014).
WO 2018/033584—VIGNOLINI, S., PARKER, R. & FRKA-PETESIC, B. Self-assembled nanocrystals. (2018).
Zhang, Y. P. et al. Nanocrystalline cellulose for covert optical encryption. J. Nanophotonics 6, 063516 (2012).
Zhao, T. H. et al. Coating of responsive photonic cellulose nanocrystal microfilm arrays. Adv. Funct. Mater. 29, (2019), 1804531.

1. A process for producing structurally coloured films, the process comprising the steps of:
a) depositing a nanocrystal suspension comprising cellulose nanocrystals onto a substrate;
b) spreading the nanocrystal suspension across the substrate using a spreader;
c) ageing the nanocrystal suspension to partially or completely recover the cholesteric structures lost during deposition and spreading;
d) drying the deposited nanocrystal suspension so that the nanocrystals self-assemble to form a structurally coloured film;
e) annealing the structurally coloured film to increase the water resistance of the film.

2. The method of claim 1, wherein the nanocrystal suspension comprises neutralised, partially neutralised or acidic form cellulose nanocrystals.

3. The method of claim 1 or 2, wherein the nanocrystal suspension is biphasic or anisotropic.

4. The method of any one of the preceding claims, wherein the coating process is a roll-to-roll printing process.

5. The method of any one of the preceding claims, wherein the drying step is carried out at 10 to 250° C., preferably at 10 to 70° C.

6. The method of any one of the preceding claims further comprising a treating step wherein at least a portion of the substrate is modified to increase its surface energy prior to the depositing step.

7. The method of claim 6 wherein the treatment of the treating step is plasma etching or corona discharge.

8. The method of claim 6 or 7, wherein the treating step comprises treating the central portion of the substrate.

9. The method of any one of the preceding claims further comprising the step of sonicating the nanocrystal suspension before the depositing step, optionally wherein the treatment is from 0.1 to 45 s/mL, such as around 2.2 s/mL.

10. The method of any one of the preceding claims where the cellulose nanocrystal suspension comprises at least one additive, such as an acid or a base, a filler, a polymer, a salt or a functional molecule.

11. The method of any one of the preceding claims further comprising the step of peeling the structurally coloured film from the substrate.

12. The method of any preceding claim, wherein the temperature of the annealing step is from 100 to 250° C.

13. The method of any preceding claim, wherein the annealing step is carried out for from 1 minute to 120 minutes.

14. The method of any one of the preceding claims further comprising the step of dividing the structurally coloured film to produce structurally coloured particles.

15. The method of claim 14, wherein the dividing step comprises fracturing and/or grinding the structurally coloured film.

16. A structurally coloured film obtainable by the method of any one of claims 1 to 13, optionally wherein the film has a thickness of from 1.0 to 50.0 μm.

17. A structurally coloured film comprising cellulose nanocrystals, preferably neutralised cellulose nanocrystals, wherein the nanocrystals are organized into chiral nematic structures, preferably wherein the film has a thickness such that the director of a chiral nematic structure performs at least one revolution within the film, wherein the film as a thickness of 20 μm or less.

18. The structurally coloured film of claims 16 to 17, wherein the film reflects 5% or more of the incoming light at a wavelength in the range 200 to 1300 nm.

19. The structurally coloured film of claims 16 to 18, wherein the reflected light has a full width at half maximum of 150 nm or less.

20. A structurally coloured particle obtained or obtainable by the method of claim 14 or 15.

21. A structurally coloured particle comprising cellulose nanocrystals, preferably neutralised cellulose nanocrystals, wherein the nanocrystals are organized into chiral nematic structure, preferably wherein the particles have a facetted geometry corresponding to at least one chiral nematic domain.

22. The structurally coloured particle of claim 20 or 21, wherein the median average particle diameter is from 2 μm or more. 23 The structurally coloured particle of any one of claims 20 to 22, wherein the particle reflects 5% or more of the incoming light at a wavelength in the range 200 to 1300 nm.

24. The structurally coloured particle of any one of claims 20 to 23, wherein the particle is stable to immersion in water for 1 hour or more.

25. The structurally coloured particle of any one of claims 20 to 24, wherein the reflected light is red shifted by 5 nm or more upon immersion in water.
